(19) United States
(12) Patent Application Publication
(10) Pub. No.: US 2017/0055049 A1
(43) Pub. Date: Feb. 23, 2017

(54) Method and Apparatus for Signal Routing in a Multi-Plane Photonic Switch

(71) Applicants: Mohammad KIAEI, Ottawa (CA); Hamid MEHRVAR, Ottawa (CA)

(72) Inventors: Mohammad KIAEI, Ottawa (CA); Hamid MEHRVAR, Ottawa (CA)

(73) Assignee: Huawei Technologies Co., Ltd., Shenzhen (CN)

(21) Appl. No.: 14/828,019

(22) Filed: Aug. 17, 2015

(51) Int. Cl. H04Q 11/00; H04L 12/933

(52) U.S. Cl. CPC H04Q 11/0003; H04L 49/1523; H04Q 11/0005; H04Q 2011/0037

(57) ABSTRACT

A method and apparatus for routing received connection demands through a photonic switch having multiple parallel instances of a switching plane is provided. Routing respects the constraint that each cell of the switch accommodates a maximum of one lightpath. Connection demands are routed one at a time via switching plane instances where it is possible without violating the constraint. When a demand cannot be routed, a re-arrangement step is performed. A previously routed demand that conflicts with the blocked demand is identified and de-allocated. The blocked demand is then routed in place of this de-allocated demand, which is now considered blocked. The process repeats until no blocked demands remain. Attempts to route additional demands of lower priority can also be made by checking whether each lower priority demand can be routed given the configuration of the switch to route existing demands.

### CROSS-REFERENCE TO RELATED APPLICATIONS

This is the first application filed for the present invention.

### FIELD OF THE INVENTION

The present invention pertains to the field of photonic and in particular to a method and apparatus for routing signals through a multi-plane photonic switch.

### BACKGROUND

Silicon photonic integrated circuit (PIC) switches used in applications such as optical networks, computing systems and datacenters offer compact size, lower power consumption and fabric integration with various optical components on a single substrate. Various switching architectures have been proposed which offer different arrangements of switching cells, such as 1×2, 2×2 and/or 2×1 cells. Along with promising photonic switch architectures exhibiting desirable features such as low cell count, low insertion loss, low crosstalk, scalability, and flexibility, there is a requirement for efficient and fast path finding approaches for use with such switches.

In various operating regimes, a photonic switch may synchronously or asynchronously receive multiple routing requests. Each request can be interpreted as a request to establish, within a limited amount of time, a lightpath from a specified input to a specified output of the photonic switch. Signals can then be conveyed via the established lightpaths.

It is desirable to operate such photonic switches such that they accommodate received routing requests in an efficient, reliable and timely manner, without blocking an unnecessarily high number of the requests. However, achieving such a utilization of the photonic switch is not straightforward, particularly because an adequate routing solution for the necessary lightpaths is difficult to discern from the large number of potential configurations of practically sized photonic switches.

Therefore there is a need for a method and apparatus for routing signals through a multi-plane photonic switch that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide a method and apparatus for signal routing in a multi-plane photonic switch. In accordance with embodiments of the present invention, there is provided a method for routing received connection demands through a switch having multiple parallel instances of a switching plane, the multiple parallel instances disposed between an input stage and an output stage, the method comprising: for each connection demand of the of the received connection demands: determining a corresponding switching cell set indicative of switching cells of the switching plane which are used to satisfy the connection demand; determining whether a first condition holds, the first condition indicative that all switching cells of the corresponding switching cell set are unallocated for use by previously satisfied connection demands within one of the multiple parallel instances of the switching plane; and when the first condition holds, satisfying the connection demand by allocating switching cells of the switching cell set on said one of the multiple parallel instances of the switching plane.

In accordance with embodiments of the present invention, there is provided a method for routing received connection demands through a switch having multiple parallel instances of a switching plane, the multiple parallel instances disposed between an input stage and an output stage, the connection demands being received along with priority connection demands, the method comprising: satisfying the priority connection demands; for each connection demand of the received connection demands: determining whether a feasibility condition holds, the feasibility condition indicative that, given configuration of the input stage and the output stage to satisfy the priority connection demands, an optical input and an optical output of the switch, which define the connection demand, are both routable to a common one of the multiple parallel instances of the switching plane; and when the feasibility condition holds: determining a corresponding switching cell set indicative of switching cells of the switching plane which are used to satisfy the connection demand; determining whether a first condition holds, the first condition indicative that all switching cells of the corresponding switching cell set are unallocated for use by previously satisfied connection demands within one of the multiple parallel instances of the switching plane; and when the first condition holds, satisfying the connection demand by allocating switching cells of the switching cell set on said one of the multiple parallel instances of the switching plane.

In accordance with embodiments of the present invention, there is provided an apparatus for operating a switch having multiple parallel instances of a switching plane, the multiple parallel instances disposed between an input stage and an output stage, the apparatus comprising: a communication interface configured to receive plural connection demands to be accommodated by the switch; a controller operatively coupled to the communication interface and configured, for each connection demand of the of the received connection demands, to: determine a corresponding switching cell set indicative of switching cells of the switching plane which are used to satisfy the connection demand; determine whether a first condition holds, the first condition indicative that all switching cells of the corresponding switching cell set are unallocated for use by previously satisfied connection demands within one of the multiple parallel instances of the switching plane; when the first condition holds, satisfy the connection demand by allocating switching cells of the switching cell set on said one of the multiple parallel instances of the switching plane; and determine desired operating states for the allocated switching cells, the desired operating states causing the allocated switching cells to collectively establish a signal path for satisfying the connection demand; and a switch driver operatively coupled to the controller and configured to transmit control signals to switching cells of the switch to cause the switching cells to enter said desired operating states.

In accordance with embodiments of the present invention, there is provided an apparatus for routing received connection demands through a switch having multiple parallel instances of a switching plane, the multiple parallel instances disposed between an input stage and an output stage, the apparatus comprising: a communication interface configured to receive the connection demands along with priority connection demands: a controller operatively coupled to the communication interface and configured to: satisfy the priority connection demands; for each connection demand of the received connection demands: determine whether a feasibility condition holds, the feasibility condition indicative that, given configuration of the input stage and the output stage to satisfy the priority connection demands, an optical input and an optical output of the switch, which define the connection demand, are both routable to a common one of the multiple parallel instances of the switching plane; and when the feasibility condition holds: determine a corresponding switching cell set indicative of switching cells of the switching plane which are used to satisfy the connection demand; determine whether a first condition holds, the first condition indicative that all switching cells of the corresponding switching cell set are unallocated for use by previously satisfied connection demands within one of the multiple parallel instances of the switching plane; when the first condition holds, satisfy the connection demand by allocating switching cells of the switching cell set on said one of the multiple parallel instances of the switching plane; and determine desired operating states for the allocated switching cells, the desired operating states causing the allocated switching cells to collectively establish a signal path for satisfying the connection demand; and a switch driver operatively coupled to the controller and configured to transmit control signals to switching cells of the switch to cause the switching cells to enter said desired operating states.

In accordance with embodiments of the present invention, there is provided a method for routing received connection demands through a photonic switch having multiple parallel instances of a switching plane, the multiple parallel instances disposed between an input stage and an output stage. For each connection demand of the received connection demands, the method includes satisfying the connection demand when a first condition holds, the first condition indicative that all switching cells of a determined switching cell set are unallocated for use by previously satisfied connection demands within one of the multiple parallel instances of the switching plane, the switching cell set indicative of switching cells of the switching plane which are used to satisfy the connection demand, wherein satisfying the connection demand includes allocating, by a controller, switching cells of the switching cell set on said one of the multiple parallel instances of the switching plane.

In accordance with embodiments of the present invention, there is provided a method for routing received connection demands through a photonic switch having multiple parallel instances of a switching plane, the multiple parallel instances disposed between an input stage and an output stage, the connection demands being received along with priority connection demands. The method includes satisfying the priority connection demands. For each connection demand of the received connection demands, when a feasibility condition holds, the feasibility condition indicative that, given configuration of the input stage and the output stage to satisfy the priority connection demands, an optical input and an optical output of the photonic switch, which define the connection demand, are both routable to a common one of the multiple parallel instances of the switching plane. In addition, when a first condition holds, the first condition indicative that all switching cells of a determined corresponding switching cell set are unallocated for use by previously satisfied connection demands within one of the multiple parallel instances of the switching plane, the corresponding switching cell set indicative of switching cells of the switching plane which are used to satisfy the connection demand: satisfying the connection demand by allocating switching cells of the switching cell set on said one of the multiple parallel instances of the switching plane.

An object of embodiments of the present invention is to provide a method and apparatus substantially as described above, for signal routing in a multi-plane photonic switch. Another object of embodiments of the present invention is to provide a method and apparatus substantially as described above, for signal routing in a multi-plane switch such as a photonic switch or an electronic switch.

### BRIEF DESCRIPTION OF THE FIGURES

Further features and advantages of the present invention will become apparent from the following detailed description, taken in combination with the appended drawings, in which:

FIG. 1A illustrates a method for priority routing of received connection demands through a multi-plane photonic switch, in accordance with an embodiment of the present invention.

FIGS. 1B and 1C illustrate a method for priority routing of received connection demands through a multi-plane photonic switch, in accordance with another embodiment of the present invention.

FIG. 2 illustrates a method for best-effort routing of received connection demands through a multi-plane photonic switch, in accordance with an embodiment of the present invention.

FIG. 3 illustrates an apparatus for operating a multi-plane photonic switch, in accordance with an embodiment of the present invention.

FIG. 4 conceptually illustrates a multi-plane photonic switch which is operated in accordance with embodiments of the present invention.

FIG. 5A illustrates a 16×16 multi-plane photonic switch which is operated in accordance with embodiments of the present invention.

FIG. 5B illustrates selected aspects of the photonic switch of FIG. 5A.

FIG. 6 illustrates a multi-plane photonic switch which is operated in accordance with embodiments of the present invention.

FIG. 7 illustrates a switching cell of a photonic switch being operated in accordance with embodiments of the present invention.

FIG. 8 illustrates an instance of a switching plane belonging to a multi-plane photonic switch being operated in accordance with embodiments of the present invention.

FIG. 9 illustrates simulation results showing the probabilities of requiring different numbers of rearrangement operations when using a path finding method for priority routing of received connection demands through a multi-plane photonic switch, in accordance with embodiments of the present invention.

FIG. 10 illustrates another representation of the multi-plane photonic switch of FIG. 6, in accordance with embodiments of the present invention.

FIG. 11 illustrates simulation results showing the probability of routing different numbers of connection demands when using a path finding method for best-effort routing of received connection demands through a multi-plane photonic switch, in accordance with embodiments of the present invention.

It will be noted that throughout the appended drawings, like features are identified by like reference numerals.

### DETAILED DESCRIPTION

As used herein, the term “about” should be read as including variation from the nominal value, for example, a +/−10% variation from the nominal value. It is to be understood that such a variation is always included in a given value provided herein, whether or not it is specifically referred to.

Embodiments of the present invention are directed toward a method for routing plural received connection demands through a multi-plane photonic switch. The multi-plane photonic switch includes multiple parallel instances of a switching plane, each of which can be used to route signals through the photonic switch. The number of instances of switching plane is denoted by the number M, which may be a power of two, and which may in various embodiments equal four. An input stage and an output stage operate to connect various optical inputs and optical outputs of the photonic switch to selectable ones of the M switching plane instances. The selected switching plane instances are configurable to complete lightpaths from optical inputs to optical outputs. Thus, when a lightpath is to be established from a given optical input to a given optical output, both can be optically connected to a common switching plane instance. The structure of the multi-plane photonic switch will be described in more detail below. Each connection demand specifies an optical input and an optical output of the photonic switch, and satisfying the connection demand requires establishing a lightpath through the photonic switch from the specified optical input to the specified optical output. Each established lightpath passes through the input stage, a selected switching plane instance, and the output stage. Signals are then conveyed along the established lightpaths.

In various embodiments, connection demands can be received synchronously and routed together. For example, during a time slot, a batch of connection demands may be received and lightpaths for accommodating all of the connection demands can be determined. Before the next time slot starts, a controller may set up the newly determined lightpaths. In some embodiments, there may be a time gap or guard time between time slots in which to establish the new lightpaths. The calculation of lightpaths from specified inputs to specified outputs may be performed in software, or via a hardware component such as a Field Programmable Gate Array (FPGA). Therefore, it is desired that these calculations are performed quickly and in a timely manner to comply with the requirements of high-speed scalable networks.

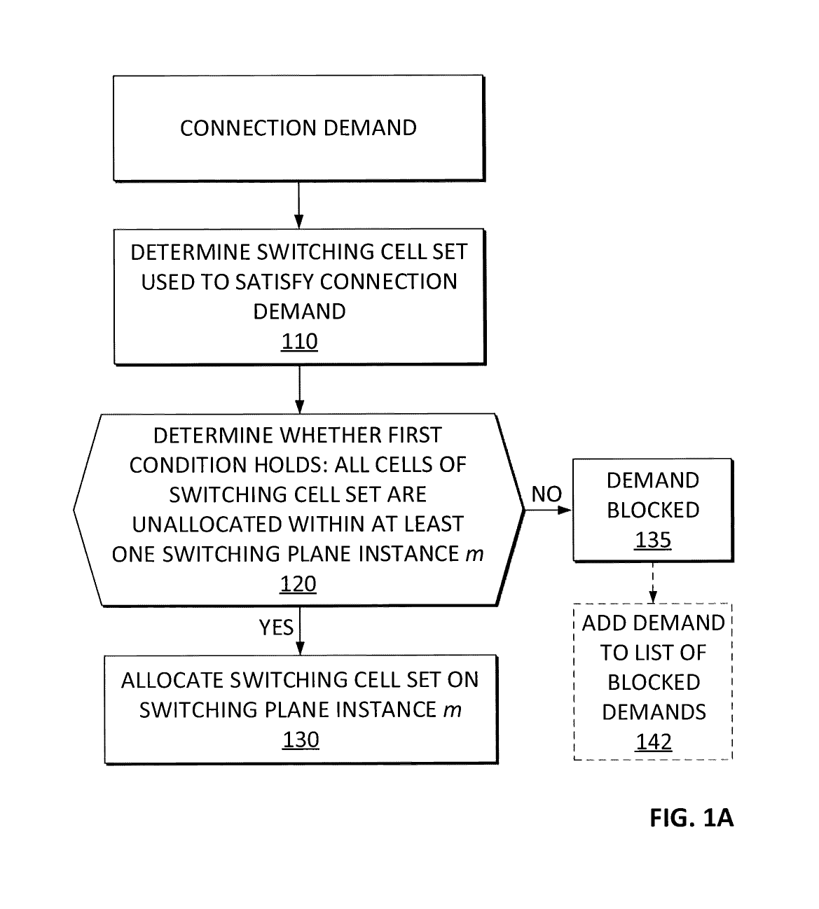

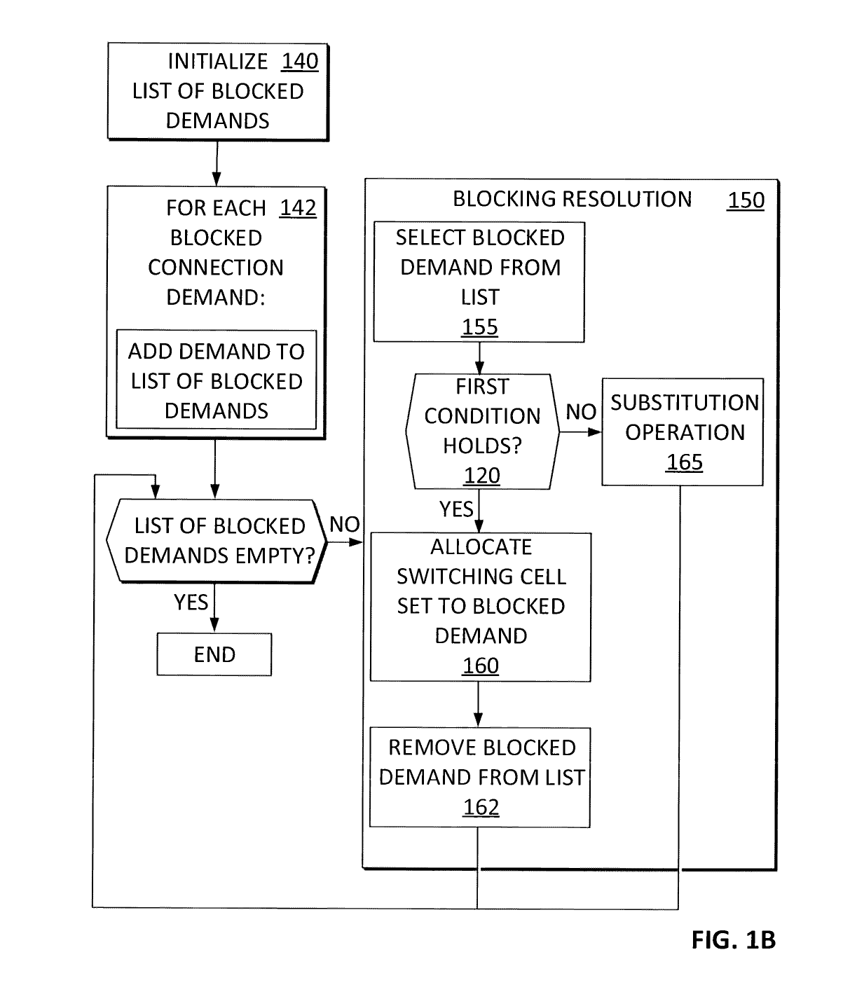

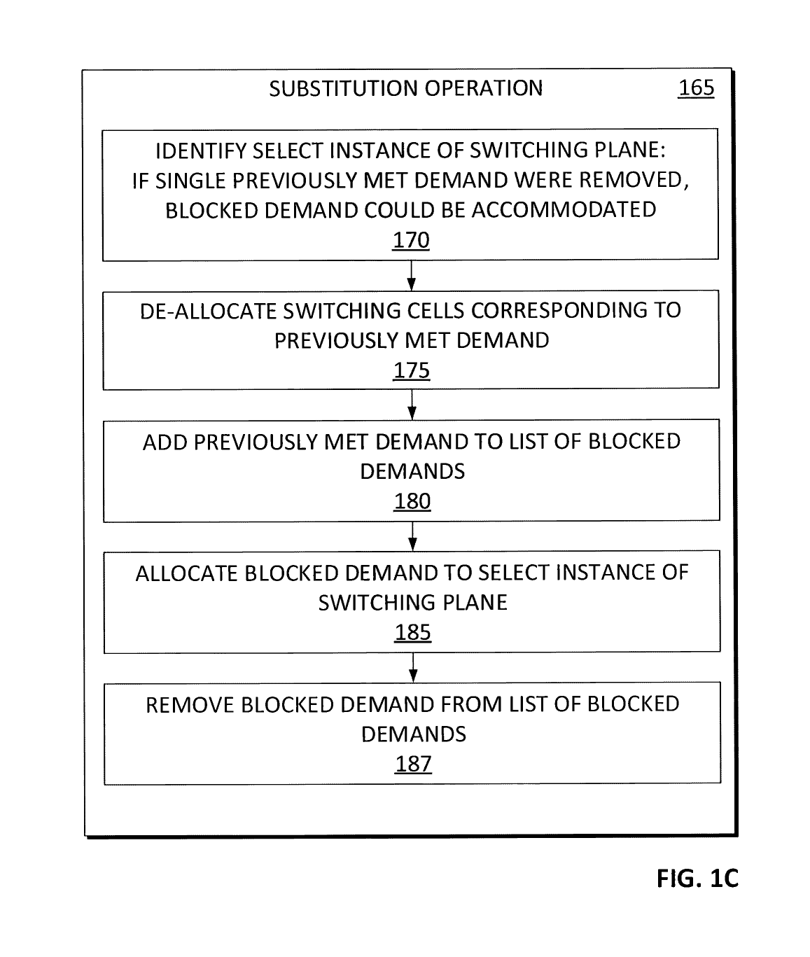

In other embodiments, connection demands can be at least partially received and routed in an asynchronous manner. In this case, substitution operations which de-allocate light paths in order to allow other lightpaths in accordance with path re-arrangement may be inhibited. FIG. 1A describes this scenario. This would inhibit the disruption of already-established lightpaths, but may result in a higher incidence of lightpath blocking. Alternatively, substitution operations may be allowed, with the understanding that already-established lightpaths which were previously routed may be disrupted if a re-arrangement/substitution operation is triggered. FIGS. 1A to 1C taken together describe this scenario. This may result in acceptable overall performance in some situations.

FIG. 1A illustrates a method for routing connection demands through a multi-plane switch in accordance with embodiments of the present invention, and may be used in both synchronous and asynchronous routing regimes. As noted above, the switch includes multiple instances of a switching plane. The method considers each connection demand in sequence, as follows. The method includes first determining 110 a switching cell set, which corresponds to those switching cells of the switching plane which are used to satisfy the presently considered connection demand. At this stage, the switching plane is a canonical representation of the switching plane instances. In other words, the switching cell set corresponds to those switching cells of any one of the switching plane instances that would be required to satisfy the presently considered connection demand, by switchably connecting those switching cells in series to establish a lightpath for satisfying the demand. The switching cell sets can be pre-computed for all connection demands or determined on an as-needed basis.

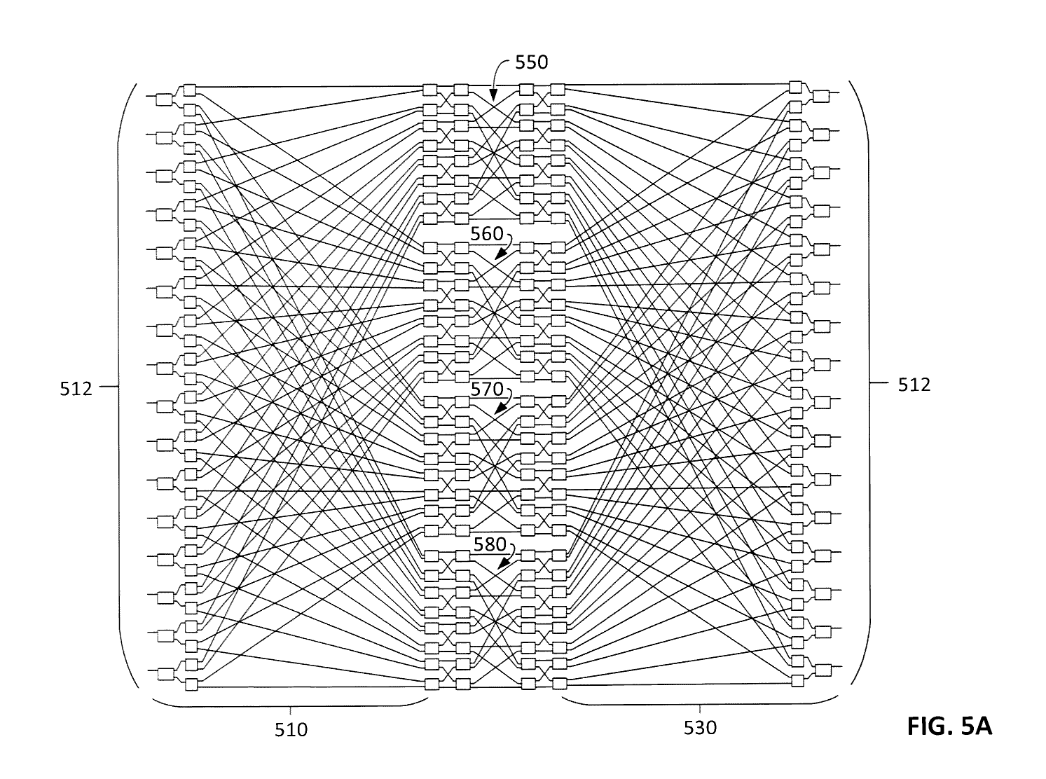

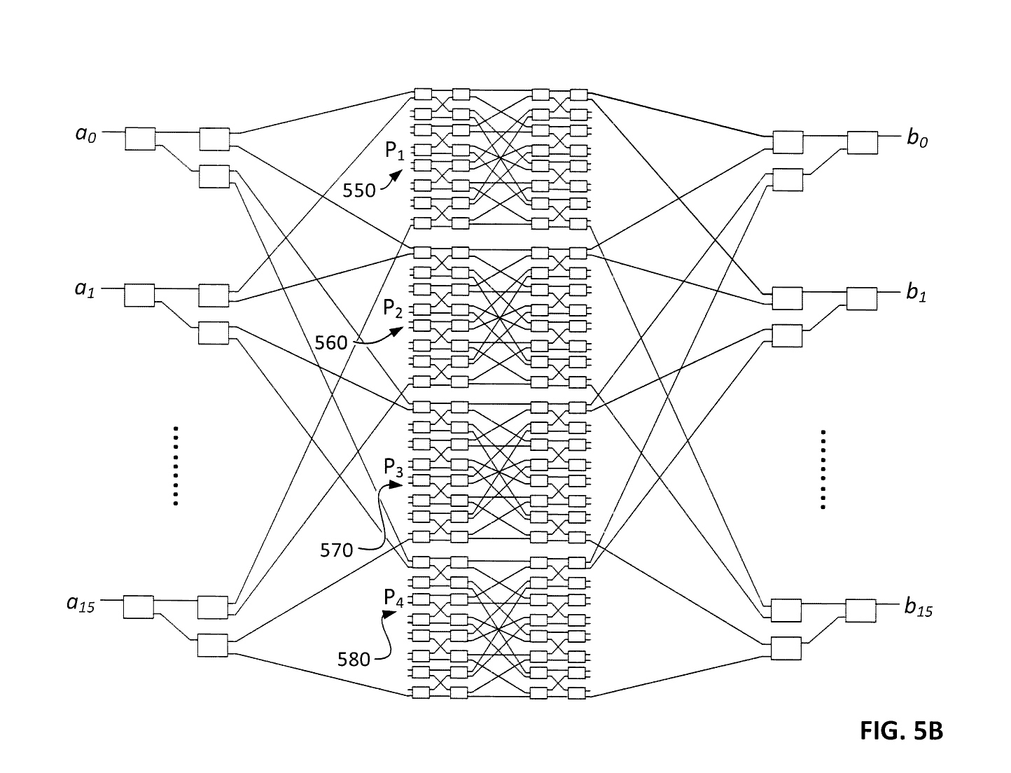

The switching cell set, along with appropriate switching cells in the input stage and the output stage of the photonic switch, are optically connected together to establish a lightpath for satisfying the connection demand. For example, referring to FIG. 5A, in order to route the uppermost optical input to the uppermost optical output via the uppermost switching plane instance 550, the uppermost two switching cells of the input stage 510 and the uppermost two switching cells of the output stage 530 are set to the “bar” configuration. Further, the uppermost four switching cells of the switching plane instance 550 are set to the “bar” configuration. It is the uppermost four switching cells of the switching plane instance 550 that correspond to the switching cell set in this case.

The method further includes, for of the presently considered connection demand, determining 120 whether a first condition holds. The first condition indicates that all switching cells of the corresponding switching cell set are unallocated within at least one of the M instances of the switching plane. A switching cell is considered unallocated when it lies outside of other switching cell sets which correspond to other connection demands that have been previously met. A demand may be met when the demand is connected via a lightpath or at least the lightpath for connecting the demand has been determined and is ready to be established for example in an upcoming time slot. In other words, the first condition holds if all of the switching cells required to satisfy the connection demand are free for use in at least one switching plane instance, in the sense that the switching cells have not been previously allocated for another use.

The method further includes, when the first condition holds, allocating 130 the switching cell set on one of the at least one of the M instances of the switching plane for which the switching cells of the switching cell set are unallocated. For definiteness, when reference is made to a switching cell set being allocated, this can also be taken to mean that the switching cells belonging to the set are allocated. In other words, the switching cells which are required to satisfy the connection demand are allocated for satisfying the connection demand in a particular instance of the switching plane for which the switching cells have not been previously allocated for another use.

The method further includes, when the first condition fails to hold, considering the demand under consideration to be blocked 135. Optionally, the blocked connection demand can also be added 142 to a list of blocked demands stored in computer memory. Blocked connection demands held in the list can subsequently be handled by a blocking resolution operation as described below with respect to FIG. 1B.

It is noted that, once a switching cell set is allocated, the demand can be considered to be met. The switching cells in the set can be controlled to establish a lightpath through the photonic switching fabric from an optical input to an optical output, both specified by the demand. The established lightpath is then used to convey optical signals through the photonic switching fabric.

A distinction exists between the terms “switching plane” and “switching plane instance.” The switching plane is a representative object, for example existing in computer memory, rather than a physical part of the photonic switch. The switching plane instance is a portion of the photonic switch which is a realization of the switching plane representative object. There are typically multiple switching plane instances arranged in parallel, each of which is represented by the switching plane representative object. The use of the switching plane concept may expedite explanation and/or computation. For example, the switching plane object can be used to compute which switching cells would be required in order to provide a lightpath from a given input to a given output. The switching plane instances can then be checked to determine whether these switching cells are currently unallocated in at least one of the instances, and the lightpath therefore capable of being established in that at least one switching plane instance.

FIGS. 1B and 1C illustrate details of a blocking resolution operation which is provided in accordance with some embodiments of the present invention. The blocking resolution operation can be performed on an iterative and as-needed basis. Prior to iteration of the blocking resolution operation, a list of blocked demands is initialized 140 as an empty list. The list of blocked demands is subsequently maintained by adding 142 blocked demands as described with respect to FIG. 1A, as well as removing 162, 187 blocked demands from the list and adding 180 new blocked demands to the list during iterations of the blocking resolution operation 150 as will be described below. In the illustrated embodiment, the initial list of blocked demands is built prior to blocking resolution. For example, the operations of FIG. 1A, including operation 137, can be performed for each connection demand in the list of connection demands, followed by one or more iterations of the blocking resolution operation 150. In this case, prior to blocking resolution, the list of blocked demands lists all connection demands for which the first condition initially failed to hold. In other embodiments, iterations of the blocking resolution operation 150 can be interleaved with the operations of FIG. 1A. For example, between some iterations of the blocking resolution operation, one or more iterations of the operation of FIG. 1A can be performed.

The blocking resolution operation 150 is repeated while the list of blocked demands is non-empty. The blocking resolution operation includes selecting 155 a blocked demand from the list of blocked demands. The blocking resolution operation further includes, when the first condition holds for the blocked demand, allocating 160 the switching cell set corresponding to the blocked demand to one of the M instances of the switching plane for which the switching cell set is unallocated. As mentioned above, the first condition indicates that, for the demand under consideration, in this case the blocked demand, all of the switching cells required to satisfy the demand are free for use in at least one switching plane instance. The first condition, as specifically applied to the blocked demand, is also referred to herein as a second condition. Along with the allocation 160, the blocked demand may be removed 162 from the list of blocked demands.

The blocking resolution operation further includes, when the first condition currently fails to hold for the blocked demand, performing a substitution operation 165, which is illustrated in detail in FIG. 1C. The substitution operation includes identifying 170 a target one of the M instances of the switching plane. The select instance of the switching plane identified by the condition that all switching cells of the switching cell set corresponding to the blocked demand would be unallocated within the select instance of the switching plane if a single one of the previously met demands were removed (and hence the first condition would be satisfied). In other words, a switching plane instance is sought where removal of one previously met demand would allow the currently considered blocked demand to be met. The substitution operation further includes de-allocating 175 the switching cell set corresponding to this identified one of the previously met demands. The substitution operation further includes adding 180 this identified one of the previously met demands to the list of blocked demands, and allocating 185 the blocked demand to the target one of the M instances of the switching plane. The blocked demand can then be removed 187 from the list of blocked demands. In various embodiments, rather than allocating the blocked demand immediately, the blocked demand may be allocated to the target one of the M instances of the switching plane on a subsequent iteration of the blocking resolution operation as applied to the blocked demand.

In some embodiments, the method of FIG. 1A is able to allocate a majority of combinations of connection demands without blocking, but can fail to allocate a minority of combinations of connection demands without blocking. In such embodiments, the method of FIG. 1B may be operable to allocate all different combinations of connection demands without blocking. The connection demands can thus be guaranteed to be satisfied. Blocking in this sense refers to the condition that at least one connection demand cannot be satisfied due to failure of the first condition.

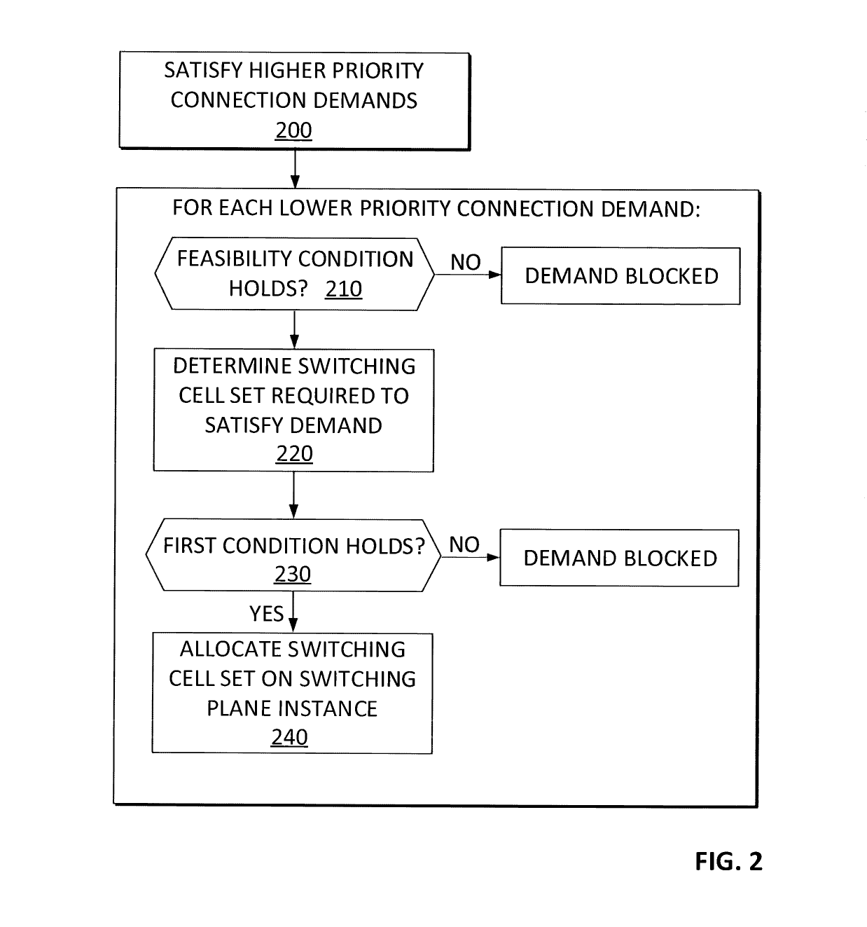

Embodiments of the present invention are directed toward a method for “best effort” routing of received connection demands through a multi-plane photonic switch. The connection demands can be synchronously received or asynchronously received. Asynchronously received connection demands can be received in a sequence of batches. In this embodiment, the connection demands are received in addition to priority connection demands, such as “priority” or “guaranteed” connection demands. The priority connection demands may be received synchronously or asynchronously with the connection demands. Having reference to FIG. 2, the method includes satisfying 200 the plurality of priority connection demands. This may be performed for example by the methods described above with respect to FIGS. 1A and 1B or by another means. The method further includes, for each demand of the one or more connection demands: determining 210 whether a feasibility condition holds. The feasibility condition indicates that, given configuration of the input stage and the output stage to satisfy the priority connection demands, an optical input of the demand (currently being considered) and an optical output of that demand are both routable to common ones of the M instances of the switching plane. The method further includes, when the feasibility condition holds, determining 220 a corresponding switching cell set indicative of switching cells of the switching plane which are required to satisfy the demand. The method further includes, when the feasibility condition holds, determining 230 whether a first condition holds. As previously mentioned, the first condition indicates that all switching cells of the switching cell set corresponding to the demand are unallocated within at least one of the common ones of the M instances of the switching plane. Again, a switching cell is considered unallocated when it lies outside of other switching cell sets which correspond respectively to other connection demands that have been previously met. That is, a switching cell is unallocated if it belongs to the complement of the union of the other already-established switching cell sets. The method further includes, when the first condition holds, allocating 240 the switching cell set on one of the common ones of at least one of the M instances of the switching plane. In particular, the switching cell set is allocated on one of the instances of the switching plane in which all switching cells of the switching cell set corresponding to the demand are unallocated.

In various embodiments, evaluation of the first condition is inhibited when the feasibility condition fails to hold. This can improve computational efficiency since the connection demand will not be routable when the feasibility condition fails to hold, regardless of the status of the first condition.

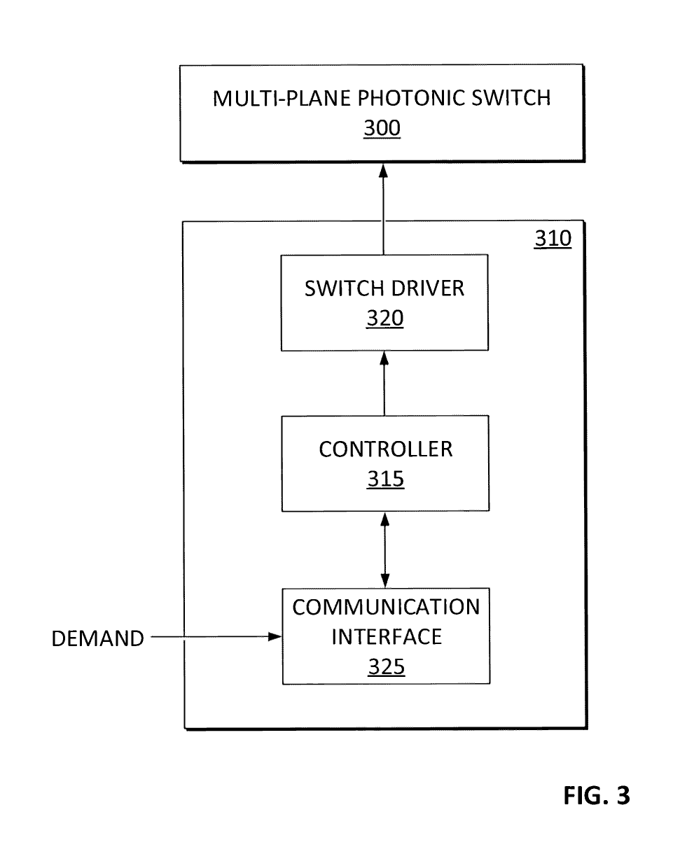

Embodiments of the present invention are directed toward an apparatus for operating a multi-plane photonic switch 300. Having reference to FIG. 3, the apparatus 310 includes a controller 315 which may be functionally subdivided into various modules for performing various respective control tasks as described herein. The controller 315 may include an appropriately configured microcontroller, microprocessor operatively coupled to memory, or the like. The apparatus includes a communication interface 325 which is communicatively coupled to the controller 315 as well as to other devices in the optical network and configured to receive connection demands for establishing lightpaths through the multi-plane photonic switch. In some embodiments, the communication interface may be configured to respond to requests to establish lightpaths, for example to indicate that the request is blocked for a given photonic switch. The apparatus includes a switch driver 320 which is communicatively coupled to the controller 315 as well as to the photonic switch 300 itself. The switch driver 320 is configured to provide control signals, such as binary control signals causing specified switching cells of the photonic switch to operate in bar or cross configuration, in order to establish lightpaths as specified by the controller. In some embodiments, a single controller may control plural photonic switches, for example provided in a bank of parallel switches. Each photonic switch includes multiple inputs for receiving optical signals and multiple outputs for providing optical signals. The multiple inputs are connected in controllable combinations to the optical outputs by operation of the switch, as directed by the controller.

The controller is configured to receive connection demands from the communication interface 325 and perform various operations, such as computational operations, associated with routing the connection demands. The computational operations being carried out by the controller correspond to the operations described above and elsewhere herein with respect to the methods provided in accordance with embodiments of the present invention. For clarity of exposition, these operations are not repeated here in the specific context of the controller. Rather, the implementation of these operations can be performed by computer processor instructions to be implemented by the controller, for example including for loops, while loops, if-then statements, memory storage and retrieval operations, and the like, as would be readily understood by a worker skilled in the art. Similarly, methods as described herein may be implemented using a computer, microprocessor operatively coupled to memory, microcontroller, or other appropriate technology.

Embodiments of the present invention are directed toward an apparatus comprising a multi-plane photonic switch and a controller, both as described above. The apparatus may be an optical network node or portion thereof, for example.

Embodiments of the present invention relate to a method and apparatus for routing connection demands through a photonic switch architecture, such as a switch architecture having multiple parallel instances of a switching plane. The switching plane instances are arranged in parallel and located between an input stage and an output stage. In particular, connection demands are routed in a two-aspect approach. In the first aspect, lightpaths for carrying signals through the photonic switch are established where it is possible to do so. Each lightpath satisfies one of the connection demands, and establishing of lightpaths may be performed one at a time. It is deemed possible to establish a lightpath when a set of switching cells is present in at least one of the switching plane instances of the photonic switch which is currently unallocated and which is capable of providing part of the lightpath (in addition to parts provided by the input stage and output stage) by optically connecting the switching cells of the set in series, for example via waveguides. In the second aspect, those connection demands which cannot currently be routed (blocked demands) are accommodated by a re-arrangement process, in which some of the currently established lightpaths are de-allocated to make room for the blocked demands, and the blocked demands are then routed. The re-arrangement process is also referred to as blocking resolution. The first and second aspects may be performed sequentially, for example with all of the first aspect performed as a first step and subsequently all of the second aspect performed as a second step. The first and second aspects may alternatively be interleaved such that parts of the first aspect are performed before parts of the second aspect, followed by further parts of the first aspect, and so on. The first and second aspects can be repeated until a predetermined number of signal routes are established through the photonic switch, and/or no blocked signals remain which could be feasibly routed. It is further noted that the second aspect may not be required in all instances of operation, since it may often be possible to route all signals without re-arrangement. In some embodiments, blocking resolution can proceed as follows. For each of the currently blocked connection demands, a set of one or more conflicting connection demands which are currently routed are identified. These conflicting connection demands are then de-allocated and the blocked connection demand is routed. De-allocation involves considering the switching cell set which accommodates the demand as being unallocated. The de-allocated connection demands are then considered to be blocked demands and the blocking resolution step is repeated as necessary. Repetition may be performed until no blocked connection demands remain. The observation that the photonic switch architecture is re-arrangeably non-blocking may be used as a guarantee that the state in which all connection demands are accommodated can be achieved.

Embodiments of the present invention provide approaches to routing and/or optical path finding that focuses on finding non-blocking paths with relatively low computational cost. Such approaches may be usable to specify lightpaths connecting optical inputs and optical outputs of the switch, using multiple parallel instances of a switching plane to accommodate parts of the lightpaths. In some embodiments and for some switch architectures having N optical inputs and N optical outputs, up to N different lightpaths can be specified.

In some embodiments, it may be required to find and establish lightpaths in a within a small fraction of a nominal connection duration time, in order to avoid introducing excessive delay into the communication network. When connection durations are potentially short, (e.g., on the order of one microsecond) this imposes a strict time requirement for path finding.

Embodiments of the present invention are used in situations in which multiple connection demands are received synchronously, for example in accordance with a time-slotted system in which demands are received and the photonic switch is to be re-arranged to accommodate the demands within a predetermined time frame. In contrast with an asynchronous setting, in which connection demands arrive one-by-one, a synchronous setting is more amenable to optimal routing and blocking probability minimization, since there is less need to “route around” pre-existing lightpaths which are to be left undisturbed.

Embodiments of the present invention may be used in situations in which multiple connection demands are received asynchronously, for example one at a time or in multiple batches of demands received at different times. As previously mentioned, in some embodiments, re-arrangement or substitution operations as described herein may be inhibited or restricted such that previously established or planned lightpaths for accommodating previously received connection demands are left undisturbed. In other embodiments, such re-arrangement or substitution operations may be allowed to disrupt previously established or planned lightpaths in some or all cases, with the understanding that this may impact communication on the disrupted lightpath. Various “best effort” routing techniques as described herein do not require a re-arrangement or substitution operation, and hence may be implemented similarly for both synchronous and asynchronous settings.

Embodiments of the present invention may be implemented with relatively low computational complexity when compared to other the existing routing algorithms for example for Benes networks.

Embodiments of the present invention capitalize on the observation that certain multi-plane photonic switch architectures, as described herein, are re-arrangeably non-blocking, particularly in the context of synchronous routing and a one signal per switching cell constraint, which may also be referred to as a “route condition”. A method and apparatus for efficient path finding for such switch architectures is provided. In some embodiments, zero path blocking, that is, guaranteed routing of all demands, can be achieved for a limited number of connection demands, for example 16 connection demands in the case of a 16×16 switch architecture as illustrated in FIG. 5A.

The one signal per switching cell constraint or “route condition” may be imposed in order to mitigate potential crosstalk between lightpaths which might otherwise share a switching cell. Various operations as described herein, such as evaluating a “first condition” indicative that required switching cells have not been previously allocated for accommodating other lightpaths, are used to impose the one signal per switching cell constraint.

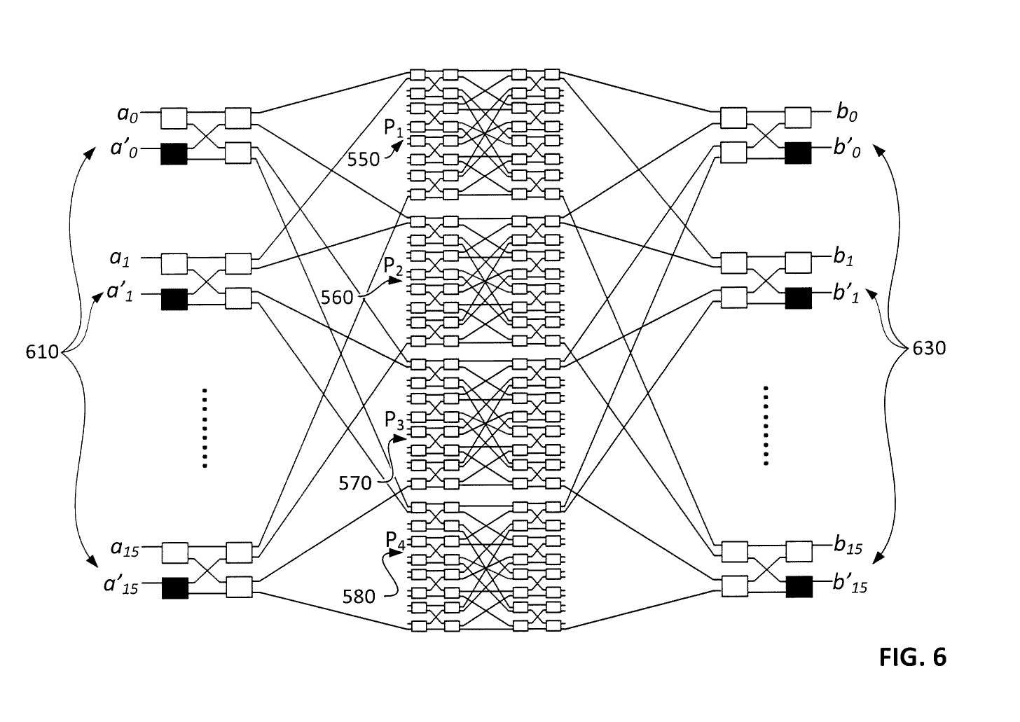

Embodiments of the present invention capitalize on the observation that certain multi-plane photonic switch architectures, as described herein, cannot be non-blocking for more than a limited number of connection demands. For example, when 16 additional connections are added to the 16×16 switch architecture of FIG. 5A, resulting in the switch architecture of FIG. 6, at least some of the 16 additional connections may be unroutable. A method and apparatus for efficient “best effort” path finding is provided for such scenarios, for example to efficiently utilize the switch cells which have not been used for routing the first 16 “priority” or “guaranteed” connection demands.

### Photonic Switch Architecture

Embodiments of the present invention are applicable to operation of multi-plane photonic switches, such as silicon-based Photonic integrated Circuit (PIC) switches. A multi-plane photonic switch includes multiple instances of a switching plane, an input stage, and an output stage. Each switching plane, as well as the input stage and the output stage, typically comprise an arrangement of controllable optical switching cells, such as 2×2 switching cells, which are operatively coupled to one another. The input stage and the output stage operate to connect optical inputs of the photonic switch to optical outputs of the photonic switch via specified instances of the switching plane. For example, if it is desired to establish a lightpath from optical input A to optical output B, the input stage can be controlled to establish a lightpath from optical input A to a given input of switching plane instance X, and the output stage can be controlled to establish a lightpath from a given output of switching plane instance X to optical output B. Switching plane instance X can be controlled to establish a lightpath from the given input to the given output.

Embodiments of the present invention relate to operation of photonic switches, such as silicon-based photonic integrated circuit switches, comprising interconnected switching cells, such as typical 2×2 switching cells. Such switching cells may be, for example, 2×2 Mach-Zehnder interferometer cells, 1×N/N×1 multi-mode interferometer cells, 2×2 micro-ring resonators, or the like. 2×2 switching cells having a first and second input and a first and second output may be operable in either a “bar” or pass-through configuration or in a “cross” configuration. A control signal to the switching cell may dictate which configuration is present. In the bar configuration, a signal at the first input is passed to the first output and a signal at the second input is passed to the second output, while in the cross configuration, a signal at the first input is passed to the second output and a signal at the second input is passed to the first output. Basic operation of photonic switches of this type would be readily understood by a worker skilled in the art, for example as set forth in U.S. Patent Application Publication No. 2015/0055951.

The use of multiple instances of switching plane within a photonic switch may provide for a larger number of potential lightpaths from optical inputs to optical outputs. For example, if a lightpath is blocked in one switching plane instance, it may not be blocked in another switching plane instance. This in turn increases the probability that a connection demand can be accommodated. However, computational complexity may also increase.

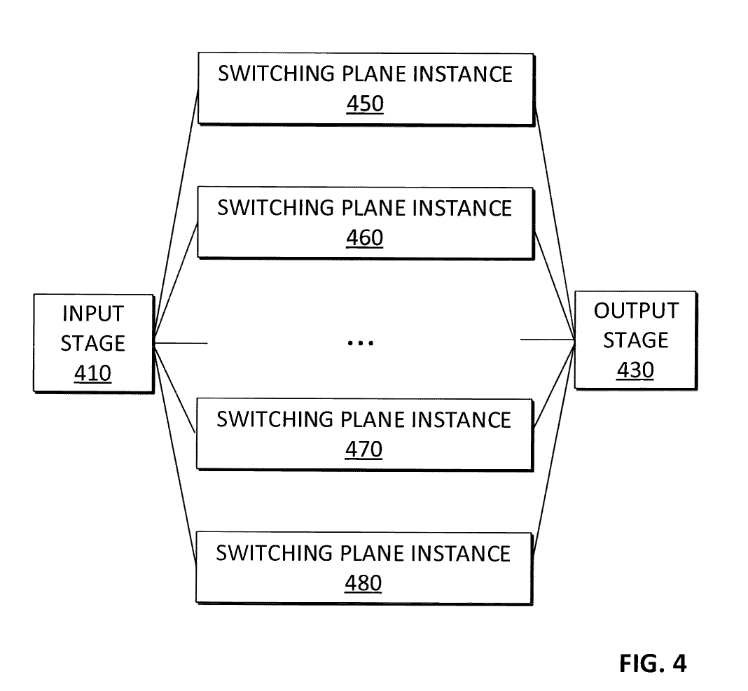

FIG. 4 conceptually illustrates a multi-plane photonic switch which is operated in accordance with embodiments of the present invention. The switch includes an input stage 410, an output stage 430, and M switching plane instances including instances 450, 460, 470, 480. The input stage is configured to receive signals from up to N different optical inputs and establish an optical connection from each of these optical inputs to a selected one of the switching plane instances, via switching cells of the input stage. The output stage is configured, for each of up to N different optical outputs, to establish an optical connection from a selected one of the switching plane instances to that optical output, via switching cells of the output stage. The switching plane instances are configured to establish lightpaths from inputs to outputs thereof. The input stage, output stage, and switching plane instances, are cooperatively configured to establish desired lightpaths through the photonic switch from optical inputs to optical outputs. The availability of M switching plane instances operating in parallel means that, if one of the switching plane instances cannot be used to establish a desired lightpath, for example due to the existence of a conflicting lightpath therein, one of the other switching plane instances may be usable for establishing the desired lightpath. As can be seen, as the number M increases, more potential routes are opened up. However, a large value for M would lead to an unfeasibly expensive and complex photonic switch.

FIG. 5A illustrates a 16×16 multi-plane photonic switch in accordance with embodiments of the present invention. The switch includes an input stage 510, an output stage 530, and four switching plane instances 550, 560, 570, 580. The input stage 510 is configured to receive signals from 16 different optical inputs 512, while the output stage 530 is configured to provide signals to 16 different optical outputs 532. The input stage includes a set of three switching cells associated with each optical input, which can be operated to establish a lightpath between that optical input and a selected one of the four switching plane instances. Similarly, the output stage includes a set of three switching cells associated with each optical output, which can be operated to establish a lightpath between a selected one of the four switching plane instances and that optical output.

The four switching plane instances 550, 560, 570, 580 each have 16 inputs and 16 outputs. However, unlike the input stage 510 and the output stage 530, pairs of inputs to a switching plane instance are coupled to a common switching cell. Each switching plane instance corresponds to a particular switch architecture capable of establishing lightpaths from inputs to outputs thereof.

The architecture of FIG. 5A includes 4 switching plane instances each having 16 inputs and 16 outputs. The total number of 2x2 switching cells is 224 and the total number of switching cell stages is eight. The architecture can be scaled to other numbers of inputs and outputs and/or other numbers of switching cell instances.

FIG. 5B illustrates the architecture of FIG. 5A, but with portions of the input stage 510 and output stage 530 hidden for clarity. Optical inputs are indexed by aᵢ, optical outputs are indexed by bᵢ, and switching plane instances are indexed by Pᵢ.

Further details on embodiments of this type of optical switch can be found in U.S. patent application Ser. No. 14/821,034 titled Optical Switch Architecture, which is hereby incorporated by reference in its entirety.

FIG. 6 illustrates a multi-plane photonic switch provided in accordance with other embodiments of the present invention. This switch is identical to that of FIGS. 5A and 5B, except that 16 additional inputs 610 and 16 additional outputs 630 are coupled to the input and output stages. The switch can be characterized as a 16×16 switch augmented with 16 additional optical inputs and optical outputs, for a total of 32 optical inputs and optical outputs. Notably, each additional input and output requires only one additional 1×2, 2×1 or 2×2 switching cell, which is coupled to the second tier of switching cells of the input and output stages. Although this configuration nearly doubles the ratio of inputs/outputs to the number of switching cells, it may also suffer from a higher incidence of path blocking.

The 16 additional inputs may allow for use of unallocated lightpaths through the photonic switch in a best-effort manner. This may potentially provide for at least some additional throughput through the switch. In some embodiments, the 16 additional inputs may be used for capacity enhancement of the switch.

In some embodiments, the 16 additional inputs may be used for traffic protection in a multi-switch system. For example, if one of several (for example five) switches in a group fails, the remaining switches in the group may each take on additional parts of the load previously handled by the failed switch. The additional inputs of each switch may be used for taking on this additional load due to the failed switch. In one embodiment, each of the remaining for switches takes on four of the 16 connections previously handled by the failed switch. Moreover, when multiple switches attempt to take on the additional load in a “best effort” manner, there may be a higher probability that each lightpath can be routed through one of the multiple switches. As such, in one embodiment, each of the multiple switches may attempt to service the additional load, and when one of the switches successfully accommodates a lightpath of the additional load, the remaining switches may refrain from attempting to accommodate that lightpath. Embodiments of the present invention may relate to the photonic switch architecture of FIG. 6 in which a particular half of the inputs and outputs are initially or wholly disregarded, thus leading to the consideration of the photonic switch architecture of FIGS. 5A and 5B. For example, for all values i in FIG. 6, either aᵢ or aᵢ′ is disregarded and either bᵢ or bᵢ′ is disregarded. The disregarded inputs and outputs can be later used to provide “best effort” routing. In some embodiments, other allocations of which half of the inputs and outputs are used for initial routing and which half of the inputs and outputs are initially disregarded and potentially used for “best effort” routing may be implemented. Performance considerations such as blocking probabilities may depend on the allocation in use.

In view of the above, embodiments of the present invention comprise or relate to a photonic switch comprising a plurality (M) of instances of a switching plane, an input stage, and an output stage. Each instance of the switching plane includes N inputs, N outputs, and a plurality of switching cells, and is configured to controllably route one or more of the N inputs to one or more of the N outputs via operation of those switching cells. The input stage includes N optical inputs operatively coupled to another plurality of switching cells. The input stage is configured to controllably route some or all of the N optical inputs to individually selected instances of the switching plane. In particular, each of the N optical inputs of the input stage is connected, via the input stage, to a corresponding one of the N inputs of the appropriate instance of the switching plane. The output stage includes N optical outputs operatively coupled to yet another plurality of switching cells. The output stage is configured to controllably feed some or all of the N optical outputs from individually selected instances of the switching plane. In particular, each of the N optical outputs of the output stage is connected, via the output stage, to a corresponding one of the N outputs of the appropriate instance of the switching plane.

Embodiments of the present invention are configured to respect a routing constraint which requires that each switching cell of the photonic switch accommodates a maximum of one established lightpath and/or optical signal thereof. This routing constraint mitigates the potential for first-order crosstalk, in which two signals, typically having the same carrier wavelength, passing through the same 2×2 switching cell can intermix to a limited degree due to the phenomenon of signal leakage, for example according to the Extinction Ratio of the switching cell. However, imposition of such a routing constraint limits the number of potential routing solutions for the photonic switch.

In more detail with respect to signal leakage, while the majority of a signal at one of the cell inputs is routed to the intended output, a certain amount of input signal power may leak to the non-intended output. Thus, for example even when a switching cell is operated in the “bar” configuration, a nominal percentage of the signal presented at the first input may appear at the second output.

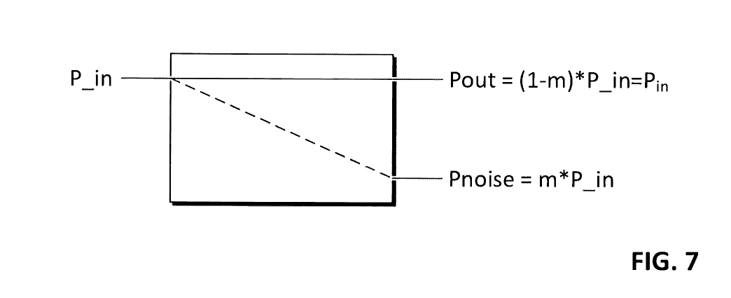

The amount of signal leakage in a cell can be described in terms of the Extinction Ratio (ER) of a cell. FIG. 7 illustrates a switching cell operating in the “bar” configuration, so that, for an input signal having power level Pᵢₙ, a proportion (1−m) of the input power is available at the first, intended output across from the input, while a proportion (m) of the input power is leaked to the second, unintended output. The value of m is typically substantially less than 0.5, for example in may be equal to 0.01. The output signal power is therefore Pₒᵤₜ=(1−m)Pₘ, while the noise power is Pₙₒᵢₛₑ=(m)Pᵢₙ. When two lightpaths are routed through a regular switching cell, first-order crosstalk can occur. More specifically, first-order crosstalk results from the signal leakage of a first lightpath provided at one input of a cell directly coupling onto an output used for passing a second lightpath through the same cell.

Although the present description pertains primarily with respect to photonic or optical switches, it is contemplated that various embodiments of the present invention can be implemented for use in other types of switches, such as electronic switches having 2×2 switching cells configured for passing electronic signals. For such electronic switches, the switch architecture and constrains may be as described above, with the photonic switching cells replaced by equivalent electronic switching cells. Further, for electronic switches, the term “lightpath” may be replaced with the more general term “signal path,” for example corresponding to a path for electronic signals.

### Rearrangeably Non-Blocking Characteristic

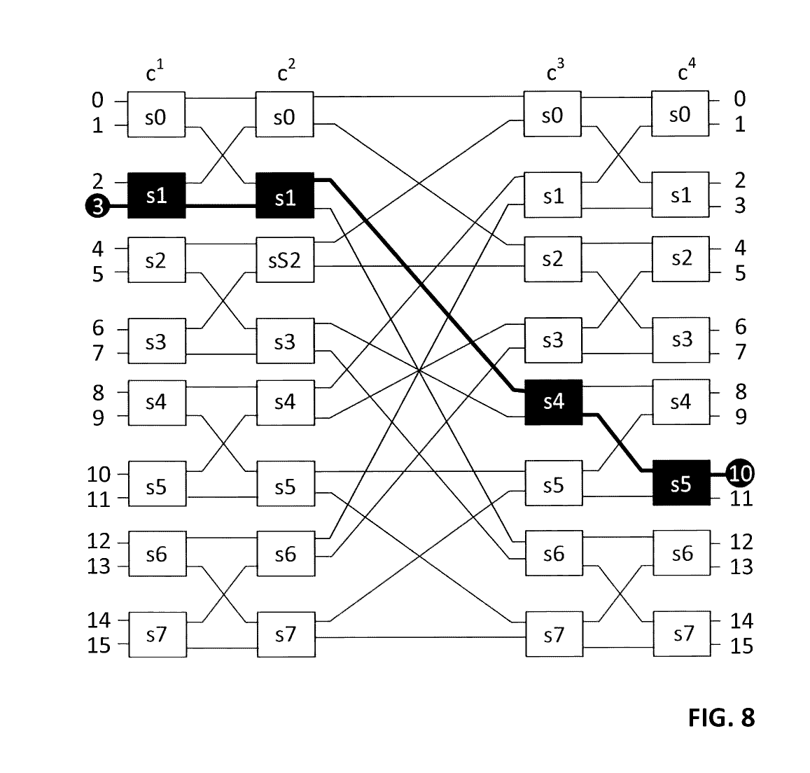

The following technical treatment relates to the rearrangeably non-blocking characteristic of certain multi-plane photonic switches, such as the switch illustrated in FIG. 5 or the switch as illustrated in FIG. 6 when the number of inputs and outputs being considered is limited. FIG. 8 illustrates one of the M 16×16 switching plane instances of such a photonic switch. Equivalently, FIG. 8 illustrates a canonical switching plane object which can be taken as a representation of each of the M switching plane instances.

The present treatment is directed to a switch having M=4 switching plane instances. Each switching plane instance is a 16×16 switch component having four columns of eight switching cells. The inputs and output are indexed from 0 to 15 and the switching cells in columns c¹ to c⁴ are indexed from s0 to s7, as shown in FIG. 8. Note that each switching plane instance can accommodate any of the connection pairs from input (a) to output (b) (0≦a, b≦15). Such a connection pair may be written as (a,b). Therefore, each switching plane instance can be considered separately.

An example connection from input 3 to output 10 of the switching plane instance is illustrated in FIG. 8. This connection requires switching cells s1, s1, s4, and s5 in columns c¹, c², c³, and c⁴, respectively. Now, due to the routing constraint which requires that each switching cell accommodates a maximum of one established lightpath, every other connection pair which requires use of one or more of these switching cells cannot be routed via this switching plane. For example, the connection pair (6, 8) requires switch cell 4 in column c³ which is already used by connection pair (3, 10).

A set of expressions for the required switch cells for each connection demand is derived below, followed by a mathematical proof that for each connection demand, all conflicting connections can be routed in three other planes. It is noted that this treatment is for illustrative purposes, and is not intended to limit the scope of the present invention.

Let S={0, . . . , 15} denote the set of inputs or outputs of a switching plane instance. Define partitions Sₙ^{k} of S as follows:

Sₙ^{k}={nk, . . . ,(n+1)k−1}, (1)

where kε{2,4, 8} is the partitioning factor and

$$n ∈ \{ \begin{matrix}0 , & … , & \frac{16}{k} - 1\end{matrix} \}$$

is the subset index. The subsets Sₙ^{k} are mutually exclusive partitions of S. That is,

$$\begin{matrix}{{⋃}^{\frac{16}{k} - 1}}_{n = 0} {S}_{n}^{k} = S , & ( 2 ) \\ {S}_{{n}_{1}}^{k} ⋂ {S}_{{n}_{2}}^{k} = ∅ , 0 \leq {n}_{1} \neq {n}_{2} \leq \frac{16}{k} - 1. & ( 3 )\end{matrix}$$

In other words, for each partitioning factor k, each integer 0≦i≦15 belongs to one and only one of the subsets indexed by n(i,k), that is:

$$i ∈ {S}_{n ( i , k )}^{k} , n ( i , k ) = ⌊ \frac{i}{k} ⌋ . \qquad ( 4 )$$

Now, define c_{a,b}^{m} as the switch cell in column (m) of the switching plane instance which is required for routing the connection pair from input (a) to output (b), where 1≦m≦4, 0≦a, b≦15, and 0≦c_{a,b}^{m}≦7. The switching cells in columns c¹ to c⁴ can be obtained from the following expressions:

c_{a,b}¹=n(a,2), (5)

c_{a,b}²=n(a,4)×2+n(b,8), (6)

c_{a,b}³=n(a,8)+n(b,4)×2, (7)

c_{a,b}⁴=n(b,2). (8)

Recall that each switching cell is constrained to accommodate at most one lightpath and/or optical signal. In other words, if one switching cell is used for one of the demands, it cannot be used for any other demand. Next, for every connection pair (a,b), the subset of connection demands which cannot be routed in the same switching plane instance is found. Namely, the connection demands that use the same switching cells as demand (a,b) in any of columns c¹ to c⁴ in the switching plane instance are specified. To this end, define D_{a,b}^{m} as the set of all connection pairs which require switching cell c_{a,b}^{m} in the switching plane instance:

D_{a,b}¹={(a₁,b₁)|a₁εS_{n(a,2)}²,b₁εS}, (9)

D_{a,b}²={(a₂,b₂)|a₂εS_{n(a,4)}⁴,b₂εS_{n(b,8)}⁸}, (10)

D_{a,b}³={(a₃,b₃)|a₃εS_{n(a,8)}⁸,b₃εS_{n(b,4)}⁴}, (11)

D_{a,b}⁴={(a₄,b₄)|a₄εS,b₄εS_{n(b,2)}²}. (11)

Proposition 1:

For every connection pair (a,b), there are at most 6 distinct connections which have common cells with connection (a,b) in one or more columns. In other words:

D_{a,b}¹∪D_{a,b}²∪D_{a,b}³∪D_{a,b}⁴|≦6. (13)

Proof:

Define D′_{a,b}^{m} as the set of connections which only belong to D_{a,b}^{m}. Given that |S_{n(a,2)}²|=2 and aεS_{n(a,2)}², there will be only one possible value for a₁ which only belongs to D_{a,b}¹, that is |D′_{a,b}¹|≦1. Using the same reasoning, |D′_{a,b}⁴|≦1. Moreover, note that if b₁εS_{n(b,8)}⁸, then D_{a,b}¹⊂D_{a,b}². Therefore, in order to have distinct connection pairs in D_{a,b}¹ and D_{a,b}², we should have b₁εS−S_{n(b,8)}⁸. Using similar reasoning, the following conditions are required in order to have distinct connection pairs in D_{a,b}¹ to D_{a,b}⁴:

D′_{a,b}¹={(a₁,b₁)|a₁εS_{n(a,2)}²,b₁εS−S_{n(b,8)}⁸}, (14)

D′_{a,b}²={(a₂,b₂)|a₂εS_{n(a,4)}⁴−S_{n(a,2)}²,b₂εS_{n(b,8)}⁸−S_{n(b,4)}⁴}, (15)

D′_{a,b}³={(a₃,b₃)|a₃εS_{n(a,8)}⁸−S_{n(a,4)}⁴,b₃εS_{n(b,4)}⁴−S_{n(b,2)}²}, (16)

D′_{a,b}⁴={(a₄,b₄)|a₄εS−S_{n(a,8)}⁸,b₄εS_{n(b,2)}²}. (17)

From (14) and (15), it is concluded that |D′_{a,b}²|≦2 and |D′_{a,b}³|≦2. Therefore:

|D′_{a,b}¹|+|D′_{a,b}²|+|D′_{a,b}³|+|D′_{a,b}⁴|≦6. (18)

Expression (18) completes the proof.

Corollary 1:

At most three switching plane instances are needed for routing connections in subsets D_{a,b}¹ to D_{a,b}⁴.

Proof:

From (14) and (17), it is concluded that D′_{a,b}¹∩D′_{a,b}⁴=Ø and |D′_{a,b}¹∪D′_{a,b}⁴|≦2. Therefore, the two connections in D′_{a,b}¹ and D′_{a,b}⁴ can be routed in one switching plane instance. Similarly, (15) and (16) say that D′_{a,b}²∩D′_{a,b}³=Ø and |D′_{a,b}²∪D′_{a,b}³|≦4. Therefore, the four connections in D′_{a,b}² and D′_{a,b}³ can be routed in two switching plane instances each containing one connection from D′_{a,b}² and one connection from D′_{a,b}³.

Corollary (1) expresses that for each connection (a,b), all conflicting connection demands can be routed in three switching plane instances, hence leaving one instance for (a,b). As a result, it can be concluded that with appropriate selection of switching plane instances, all connection demands can be successfully routed. Therefore, it is considered that the switching architecture illustrated in FIGS. 5A and 5B is a non-blocking 16×16 switch architecture. Further, the switching architecture illustrated in FIG. 6 is a non-blocking 16×16 switch architecture when the number of inputs and outputs being considered is appropriately limited such that, for all values i from 0 to 15, only one of aᵢ and aᵢ′ and only one of bᵢ and bᵢ′ are being considered for use in a guaranteed non-blocking manner.

### Path Finding for Rearrangeably Non-Blocking Switches

A path finding method for switching architectures such as the switching architecture illustrated in FIGS. 5A and 5B is presented below, in accordance with some embodiments of the present invention. Where the photonic switch has N inputs and N outputs (e.g. N=16) this method may be used to route up to N different connection maps through the photonic switch without blocking, while respecting the routing constraint that each switching cell accommodates a maximum of one established lightpath. In the presently illustrated embodiment, which for clarity is presented with respect to the switching architecture illustrated in FIGS. 5A and 5B, the path finding method includes three steps: initialization, path allocation, and blocking resolution. In the initialization step, the required switch cells in the four columns of the switching plane are found for all connection demands using expressions (5) to (8). In the second step, non-conflicting connection demands are routed in middle planes P₁ to P₄. The blocked connections in Step 2 (if any) are re-routed using blocking resolution in Step 3. In this step, one or more connections are rearranged among different planes until all the blocked connections are routed.

The pseudo-code listing below illustrates the above-mentioned path finding method in more detail. In the initialization step, the required switching cells are determined for all of the received connection demands. The required switching cells refer to the switching cells which are members of the switching cell set, that is, the set of switching cells of the switching plane which are used to satisfy the considered connection demand. Further in the initialization step, an empty list labeled BLOCKED_LIST is initialized, for example as an array variable in computer memory.

Path Finding for Photonic Switch with M Parallel Switching
Plane Instances

```
1. Initialization
Find required switching cells for all connection demands.
Initialize empty BLOCKED_LIST
2. Path Allocation
for each connection demand (a, b) do
  for index = 1:4 do
    if (a, b) is routable without conflict in switching plane instance P_{index}
    then
      Route (a, b) using switching plane instance P_{index}.
      Exit (for index) loop.
    end if
  end for
  if (a, b) is not assigned to any switching plane instance then
    Add (a, b) to BLOCKED_LIST.
  end if
end for
3. Blocking Resolution
for every connection demand (a, b) in BLOCKED_LIST do
  while (a, b) is not routed do
    for index = 1:4 do
      if (a, b) is routable w/o conflict in switching plane instance P_{index}
      then
        Route (a, b) using switching plane instance P_{index}
        Remove (a, b) from BLOCKED_LIST
        Exit while loop.
      else
        if (a, b) conflicts with one demand (x, y) in instance P_{index} then
        De-allocate (x, y) from switching plane instance P_{index}
        Add (x, y) to BLOCKED_LIST
        (Route (a, b) using switching plane instance P_{index})
        (Remove (a, b) from BLOCKED_LIST)
      end if
    end for
  end while
end for
```

In the path allocation step, an attempt is made to assign each connection demand to a switching plane instance demand in sequence. The order in which connection demands are treated can be arbitrary, as can the order in which switching plane instances (values of the index variable) are considered. A determination is made as to whether the connection demand under consideration is routable without conflict within a switching plane instance, and if so, the connection demand is assigned to that switching plane instance. A connection demand is routable without conflict if all of the switching cells of the corresponding switching cell set are currently unallocated for use in routing other connection demands. Assigning a connection demand to a switching plane instance includes labelling the switching cells of the corresponding switching cell set as being allocated. These switching cells may subsequently be configured, for example by controlling them in an appropriate “cross” or “bar” configuration so as to establish a lightpath for satisfying the connection demand. Finally, in the path allocation step, if the connection demand is not routable without conflict in any of the switching plane instances, it is added to the BLOCKED_LIST.

The blocking resolution step may be repeated until the BLOCKED_LIST is empty and all connection demands have been routed. In this step, each connection demand (a,b) in the blocked list is considered in sequence, and assigned to a switching plane (i.e. routed via that switching plane) if possible. If the connection demand (a,b) cannot immediately be routed, a search is performed for another connection (x,y) which has the property that, if (x,y) were de-allocated, (a,b) could be assigned to the switching plane previously accommodating (x,y). If such a connection is found, then (x,y) is indeed de-allocated and added to BLOCKED_LIST, and (a,b) is assigned in its place.

In one variation, immediately after (x,y) is added to BLOCKED_LIST, the currently considered connection demand (a,b) can be routed using the same switching plane instance P_{index} that (x,y) previously belonged to, and (a,b) can be immediately removed from BLOCKED_LIST. This variation avoids having to repeat evaluating whether (a,b) is routable without conflict in one or more switching plane instances.

The method presented above was simulated in MATLAB™ for one million different 16×16 connection maps. The simulation results reveal that only 1.4% of connection maps require blocking resolution in Step 3. In other words, 98.6% of connection maps in the simulation were successfully routed without any rearrangement required. The total number of blocked connections before blocking resolution was 14,134. Therefore, without blocking resolution as in Step 3, a blocking probability of P_{b}=_{/16×10}_{⁸}^{6 14,134}≅8.8×10⁻⁴ is present. Also, it is noted that there is no connection map with more than two blocked connections was observed. Another observation was that each blocked connection conflicted with only one other demand in each switch plane.

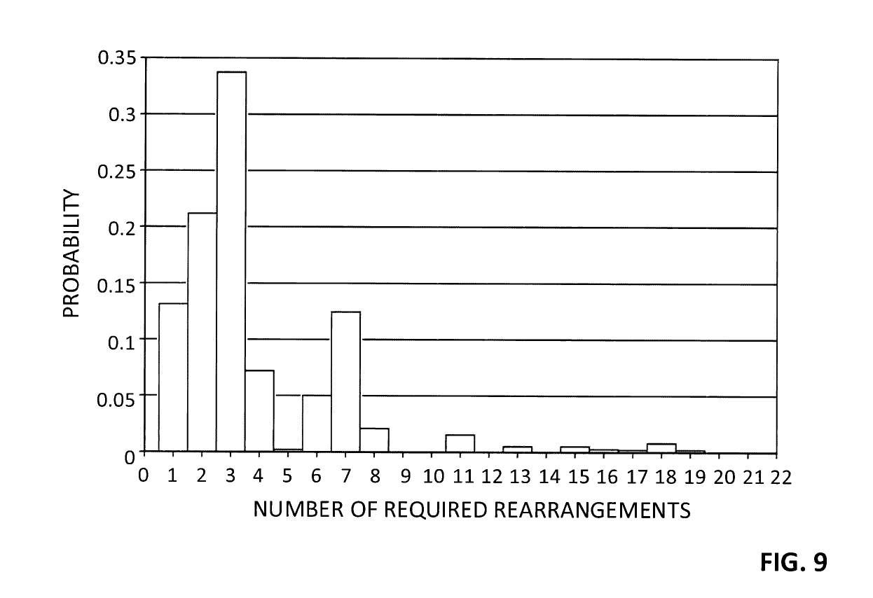

Simulation results also showed that the average number of required rearrangements for blocked connections is 3.8. That is, in those 1.4% connection maps which contain blocked connections after Step 2, an average of about four rearrangements was required to find a path for all 16 connections. FIG. 9 illustrates the probability of the number of required rearrangements in Step 3. Note that FIG. 9 only considers 1.4% of all connection maps which have non-zero number of blocked connections. As can be seen in FIG. 9, 33.83% of connection maps with blocked connections only require three rearrangements in order to find a path for all connections. FIG. 9 does not show the probability of needing more than 22 rearrangements which is about 0.1%. Furthermore, the maximum number of required rearrangements is 38 which occurred only once among all connection maps in our simulation.

Simulation results also showed that the average running time of the above method was about 4.9×10⁻⁴ seconds in some embodiments, on average. Under similar conditions, a prior art method for routing connections in a comparable Dilated Benes or Hybrid Dilated Benes switching architecture requires an average of 0.0176 seconds for each 16×16 connection map.

Although various embodiments of the present invention describe operations performed in a certain sequence, such as routing of all signals where possible, followed by re-arrangement of signal routes to accommodate those signals on a blocked list, it is recognized that the operations may be performed in a different order. For example, when the number of signals in the blocked list reaches a predetermined threshold (which may be equal to one or equal to a value greater than one), a blocking resolution routine may be triggered which attempts to clear the blocked list by de-allocating certain signal routes that block signals in the blocked list, and, in their place, allocating signal routes to accommodate signal routes in the blocked list. Operations corresponding to Steps 1, 2 and 3 in the embodiment presented above can therefore be performed in different orders. For example, initialization operations of Step 1 can be performed on an as-needed basis. As another example, some path allocation operations of Step 2 can be performed, followed by some blocking resolution operations of Step 3 when required, and possibly followed by further path allocation operations of Step 2.

### Best-Effort Routing Characteristic

Embodiments of the present invention relate to a method and apparatus for “best effort” accommodation of connection demands in addition to accommodation of a predetermined number of “priority” or “guaranteed” connection demands. As an example, referring to FIG. 6, connection demands from inputs a, to outputs b, can be guaranteed to be accommodated, while connection demands from inputs aᵢ′ to outputs bᵢ′ can be accommodated where possible tinder the best-effort treatment.

The following technical treatment relates to a property of the switch as illustrated in FIG. 6, namely that this switch cannot be non-blocking for more than 16 connections. It is noted that this treatment is for illustrative purposes, and is not intended to limit the scope of the present invention.

Assume that the following connection demands are present in a set of received connection demands: (0, 1), (1, 0), (2, 3), and (3, 2). As before, (a,b) represents a connection demand in which (a) is the input and (b) is the output. The following table shows the required switch cells in each column c′ of the switching plane for each of these connections:

Required switch cells for the example connection demands

| Connection | c¹ | c² | c³ | c⁴ |
|---|---|---|---|---|
| (0, 1) | 0 | 0 | 0 | 0 |
| (1, 0) | 0 | 0 | 0 | 1 |
| (2, 3) | 1 | 0 | 0 | 1 |
| (3, 2) | 1 | 0 | 0 | 1 |

It can be seen that all of these connections are using switching cell 0 in columns c² and c³. Therefore, these connections have to be routed in four different switching plane instances. It follows that switching cell 0 of columns c² and c³ will be utilized in all four switching plane instances of the photonic switch architecture of FIG. 6. It also follows that every connection demand, of a set of “best effort” connection demands, which requires cell 0 in column c² or c³ of the switching plane will be blocked.

It can be assumed in this example that the demands (0, 1), (1, 0), (2, 3), and (3, 2) are routed while additional conflicting demands relegated to “best effort” service are blocked. However it will be readily understood that when more than four conflicting demands are present, various sets of up to four of these conflicting demands can be selected for routing.

It is noted that all of the connections in this example belong to D_{0,1}²∩D_{0,1}³. Therefore, all connections which belong to D_{0,1}²∪D_{0,1}³ will be blocked in the “best effort” connection map. The blocked connection can be any of these 48 connections: {0 . . . 3}→{0 . . . 7} and {4 . . . 7}→{0 . . . 3}. In summary, it cannot be guaranteed that a non-blocking connectivity exists for more than 16 connections in the presently considered photonic switch architecture as illustrated in FIG. 6.

In general, if one of the following connection subsets of 4 connections in a 16×16 “priority” or “guaranteed” connection map is present, there will be at least one blocked connection in a set of 16×16 connections of a “best effort” connection map:

(a,b):aεSₙ_{₁}⁴,bεSₙ_{₂}⁴, 0≦n₁n₂≦3 (19)

The connection pairs in (19) can be illustrated for different values of n₁ and n₂ as follows:

$$\{ \begin{matrix}0 … 3 \\ 4 … 7 \\ 8 … 11 \\ 12 … 15\end{matrix} \} \to \{ \begin{matrix}0 … 3 \\ 4 … 7 \\ 8 … 11 \\ 12 … 15\end{matrix} \}$$

For each n₁ and n₂ in (19), define demand sets D₁ and D₂ as follows:

$$\begin{matrix}{D}_{1} ( {n}_{1} , {n}_{2} ) = \{ ( {a}_{1} , {b}_{1} ) \vert {a}_{1} ∈ {S}_{{n}_{1}}^{4} , {b}_{1} ∈ {S}_{⌊ \frac{{n}_{2}}{2} ⌋}^{B} \} , & ( 20 ) \\ {D}_{2} ( {n}_{1} , {n}_{2} ) = \{ ( {a}_{2} , {b}_{2} ) \vert {a}_{2} ∈ {S}_{⌊ \frac{{n}_{1}}{2} ⌋}^{B} , {b}_{2} ∈ {S}_{{n}_{2}}^{4} \} . & ( 21 )\end{matrix}$$

If the “priority” or “guaranteed” connection map contains demands from subset (19), then every connection demand in D₁(n₁,n₂)∪D₂(n₁,n₂) will be blocked in the “best effort” connection map. It can be verified that for each n₁ and n₂, |D₁(n₁,n₂)∪D₂(n₁,n₂)|=48.

Next, the probability of blocking for the 17^{th} connection is calculated. Define Pₖ^{a} and Pₖ^{b} as follows:
Pₖ^{a}=Probability of having k of the subsets in (19) in the “priority” or “guaranteed” connection map (1≦k≦4)
Pₖ^{b}=Probability that the 17th connection is one of the connections in the “best effort” connection map that will be blocked when we have k subsets in the “priority” or “guaranteed” connection map.

These probabilities can be calculated from the following equations:

$$\begin{matrix}{P}_{k}^{a} = \frac{( \begin{matrix}4 \\ k\end{matrix} ) \times ( \begin{matrix}4 \\ k\end{matrix} ) \times k \text{!} \times k \times 4 \text{!} \times ( 16 - 4 k ) \text{!}}{16 \text{!}} , & ( 21 ) \\ {P}_{k}^{b} = \frac{48 k}{256} . & ( 22 )\end{matrix}$$

Then, the probability of blocking the 17^{th} connection can be calculated as follows:

$${P}_{17} = {\sum }_{k = 1}^{4} {P}_{k}^{a} \times {P}_{k}^{b} . \qquad ( 23 )$$

Performing the numerical calculations, P₁₇=0.0017.

### Path Finding for Best-Effort Routing

Some embodiments of the present invention provide for a path finding algorithm to efficiently utilize the switch cells which have not been used for routing a first 16×16 connection map corresponding to 16 different “priority” or “guaranteed” connection demands.

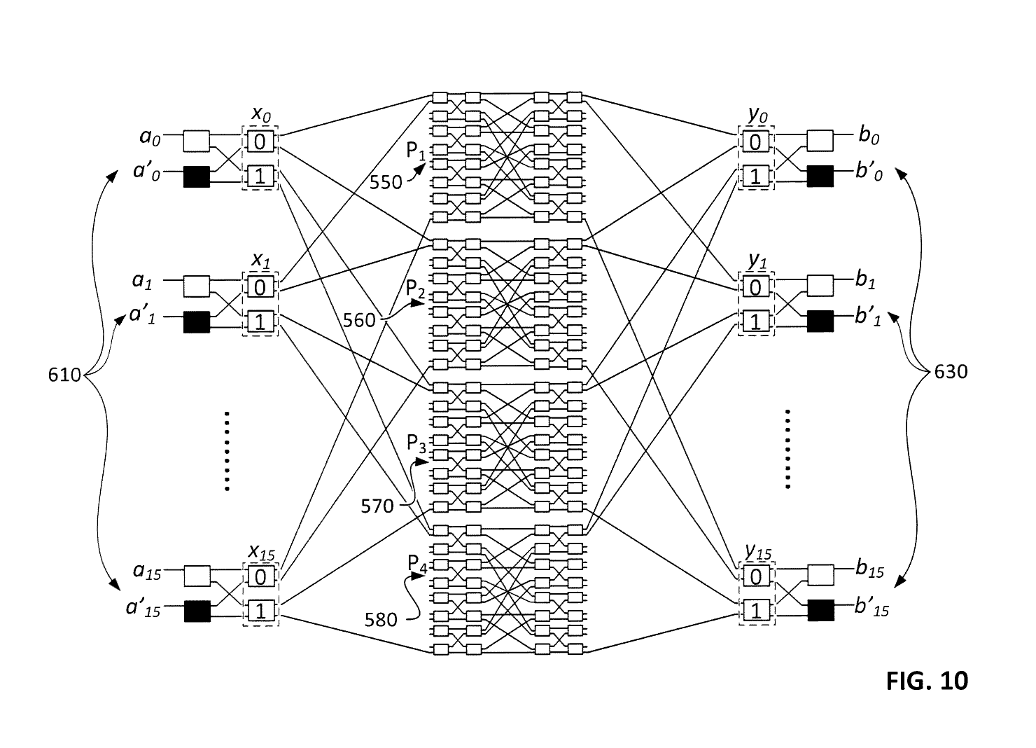

FIG. 10 illustrates the same photonic switch architecture as FIG. 6, that is with M=4 switching plane instances. Connections {a₀ . . . a₁₅}→{b₀ . . . b₁₅} are the first set of 16×16 connections which are successfully routed, for example using a method previously described. The aim of best-effort routing is to use the remaining switching cells to accommodate as many connections as possible in a second connection map {a′₀ . . . a′₁₅}→{b′₀ . . . b′₁₅}.

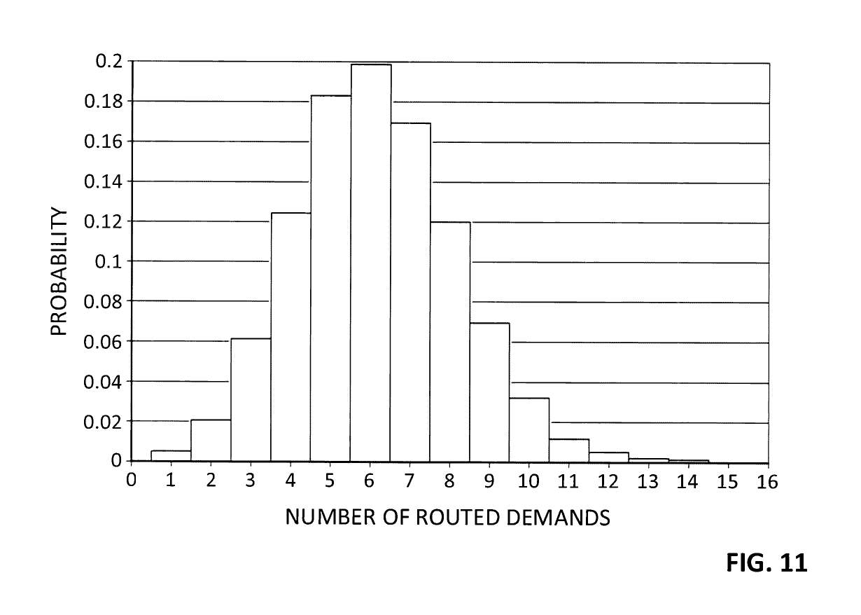

First, the status of switching cells in the second and seventh column of the photonic switch architecture, after routing the first 16×16 connection map, is determined. For this purpose, define binary variables xᵢ and yⱼ. As depicted in FIG. 11, if a connection demand (aᵢ, bⱼ) is routed in switch plane 1 or 2 then xᵢ=yⱼ=0. In general, if (aᵢ, bⱼ) is routed in switching plane instance Pₙ, then:

$${x}_{i} = {y}_{j} = ⌊ \frac{{P}_{n} - 1}{2} ⌋ , 0 \leq i , j \leq 15 , 1 \leq n \leq 4 \qquad ( 24 )$$

In order to find the available switch planes for the second map, define vectors X=[x₀, . . . , x₁₅] and Y=[y₀, . . . , y₁₅]. Then, define vectors X′=[x′₀, . . . , x′₁₅] and Y′=[y′₀, . . . , y′₁₅] as follows:

X′=X(XOR)1 (25)

Y′=Y(XOR)1 (26)

Alternatively, X′ and Y′ may be defined as the bit-wise inversion of X and Y, respectively. For every connection pair (a′ᵢ, b′ⱼ) in the second connection map, if x′ᵢ≠y′ⱼ, the connection cannot be routed, because the same switch plane is not available for input a′ᵢ and output b′ⱼ. Conversely, if x′ᵢ=y′ⱼ, an attempt can be made to find a path for connection (a′ᵢ, b′ⱼ) in planes P′₁=2×′ᵢ+1 or P′₂=2×′ᵢ+2.

The pseudo-code listing below illustrates an example of the best effort path finding method in accordance with an embodiment of the present invention. The variables and nomenclature referred to in the figure are as defined above.

Best Effort Synchronous Path Finding for Photonic Switch with M Parallel
Switching Plane Instances

```
1. Initialization
(a) Find xᵢ and yⱼ for each connection pair (aᵢ, bⱼ) in the first connection
map.
(b) Build X′ and Y′ vectors
(c) Find required cells for all connection pairs (aᵢ′, bⱼ′) in the second map.
2. Path Allocation
for each connection pair (aᵢ′, bⱼ′) do
  if xᵢ′ = yⱼ′ do
    for switching plane instances P′ = P₁′ and P₂′ do
      if (aᵢ′, bⱼ′) does not conflict with any demand in P′ then
        Assign connection pair (aᵢ′, bⱼ′) to switching plane instance P′.
        Exit (for P′) loop.
      end if
    end for
  end if
end for
```

In the initialization step, the first connection map, corresponding to the set of priority connection demands which may already be accommodated or reserved, is used to generate the X′ and Y′ vectors, as set forth above. The X′ and Y′ vectors reflect which switching planes are still able to connect to the remaining optical inputs and optical outputs, respectively. The initialization step also includes finding the required switching cells for connection pairs (aᵢ′, bᵢ′) in the second connection map, corresponding to a set of best effort connection demands. That is, for each best effort connection demand, a switching cell set is determined that is indicative of switching cells of the switching plane which are required to satisfy this demand.

In the path allocation step, each connection pair (aᵢ′, bᵢ′) in the second connection map is considered in turn to determine whether a lightpath can be established to accommodate same. The order in which connection pairs are treated can be arbitrary. To this end, a determination is made as to whether a feasibility condition holds for the connection pair under consideration. The feasibility condition is formulated as determining whether xᵢ′=yᵢ′, and indicates that, given configuration of the input stage and the output stage to satisfy the priority connection demands, an optical input of the connection pair under consideration and an optical output of that connection pair are both routable to common ones of the M instances of the switching plane.

If the feasibility condition holds, an attempt is made to assign the connection demand under consideration to a switching plane instance. The order in which switching plane instances (values of the index variable) are considered, however rather than considering all M switching plane instances, only switching plane instances P₁′ and P₂′ are considered, where P₁′ and P₂′ are formulated as above and are functions of xᵢ′=yᵢ′. For each of these switching plane instances in turn, a determination is made as to whether the connection demand under consideration is routable without conflict within a switching plane instance, and if so, the connection demand is assigned to that switching plane instance. As before, a connection demand is routable without conflict if all of the switching cells of the corresponding switching cell set are currently unallocated for use in routing other connection demands, including primary connection demands and previously satisfied best effort connection demands. Assigning a connection demand to a switching plane instance includes labelling the switching cells of the corresponding switching cell set as being allocated. These switching cells may subsequently be configured, for example by controlling them in an appropriate “cross” or “bar” configuration so as to establish a lightpath for satisfying the connection demand. Finally, in the path allocation step, if the connection demand is not routable without conflict in any of the switching plane instances, it is considered to be blocked.

The above best-effort path finding method can be adjusted in various ways. For example, operations of the initialization step may be performed on an as-needed basis during the path allocation step. The path allocation step may be performed for a predetermined number of demand pairs rather than for each demand pair. Other variations may be present as would be readily understood by a worker skilled in the art.

The above method was simulated in MATLAB™. Simulation results showed that an average of 6.12 connections can routed from the second “best effort” connection map containing 16 demands. In other words, the photonic switch architecture of FIG. 6 was observed to accommodate an average of 22 connections, 16 of which are guaranteed to be routed successfully. FIG. 11 illustrates the distribution of the number of routed connection in the second “best effort” connection map. It was observed that almost 20% of the “best effort” connection maps have six connections accommodated. It was also noted that 57 of the “best effort” connection maps have all their 16 connection demands accommodated. In other words, it was observed that the switch architecture of FIG. 6 can accommodate a maximum of 32 connections with a probability of 5.7×10⁻⁵.

### Relaxation of One-Signal-Per-Cell Constraint

As discussed above, embodiments of the present invention incorporate a “route condition” constraint which specifies that each 2×2 switching cell accommodates at most one lightpath. However, it is contemplated that this condition can be relaxed, suspended or eliminated in some embodiments of the present invention.

For example, when the signals being routed by the photonic switch are all carried by different optical wavelengths, crosstalk concerns are mitigated and switching cells can be permitted to accommodate multiple lightpaths. As another example, when the extinction ratio of the switching cells is sufficiently high, for example greater than 30 dB, crosstalk introduced by the switching cells may be adequately low that switching cells can be permitted to accommodate multiple lightpaths with acceptably low signal degradation.

In some embodiments, when the route condition is suspended, operations such as evaluating a first condition (indicative that all switching cells of the corresponding switching cell set are unallocated for use by previously satisfied connection demands) may likewise be suspended. As such, lightpaths may be established which share switching cells with previously established lightpaths. Likewise, blocking resolution and de-allocation of switching cells accommodating existing lightpaths may be inhibited.

In some embodiments, when the route condition is suspended for an N×N photonic switch augmented with N additional optical inputs and outputs, such as in FIG. 6, up to 2N connection demands may be guaranteed to be handled with equal priority using blocking resolution, substitution operations involving and de-allocation of existing lightpaths, and the like.

It is noted that, even when the route condition is suspended, other constraints may be imposed. For example, when a previously established lightpath requires a certain switching cell to be in the “cross” or “bar” configuration, use of that switching cell to accommodate a second lightpath may be limited to cases where the same “cross” or “bar” configuration is required.

In some embodiments, the route condition can be partially relaxed. For example, the route condition can be imposed for some portions of the photonic switch, such as the input stage, or the switching plane instances, or the output stage, or combinations thereof, while the route condition can be suspended for the other portions of the photonic switch. Thus, for example, switching cells within the input stage and output stage can be restricted from accommodating multiple lightpaths, while switching cells within the switching plane instances can be allowed to accommodate multiple lightpaths, or vice-versa.

As another example, a limit on the number of switching cells that may accommodate multiple lightpaths can be set. Initially, the routing condition may be suspended. However, when the number of switching cells currently accommodating multiple lightpaths reaches this limit, further handling of connection demands may be adjusted so that further establishment of lightpaths respects the route constraint.

Some embodiments of the present invention comprise evaluating whether the route condition is in force or suspended. If the route condition is in force, routing of connection demands proceeds as described in detail above. If the route condition is suspended, routing of connection demands proceeds in an alternate manner, in which multiple lightpaths can be routed through a common switching cell.

Various embodiments of the present invention relate to a method of routing connection demands through a photonic switch and/or of establishing lightpaths within the photonic switch for accommodating such connection demands. The method may be implemented for example by a computer configured to receive input, perform computations, and provide output in furtherance of such methods. The computer may be operatively coupled to memory in which program instructions are stored for execution by the computer. Inputs may include synchronously and/or asynchronously received connection demands or requests, indications of whether the connection demand or request is to be satisfied with a guaranteed level of service or a “best effort” level of service, or the like. The computer may track parameters such as current connections or lightpaths being routed through the switch, and the like. The computer may provide outputs such as control signals for operating the switching cells of the photonic switch or, in some embodiments, signals indicative that a demand is being blocked.

In some embodiments, routing operations as described herein may be carried out on an as-needed basis, in which signal routes are determined in response to synchronously and/or asynchronously received signal routing requests or connection demands. In other embodiments, routing operations may be pre-computed for various hypothetical scenarios and stored in memory, for example in a look-up table. Subsequently, when signal routing requests are received, the appropriate pre-computed routing solution can be retrieved from memory and implemented.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

1. A method for routing received connection demands through a photonic switch having multiple parallel instances of a switching plane, the multiple parallel instances disposed between an input stage and an output stage, the method comprising:
for each connection demand of the received connection demands:
satisfying the connection demand when a first condition holds, the first condition indicative that all switching cells of a determined switching cell set are unallocated for use by previously satisfied connection demands within one of the multiple parallel instances of the switching plane, the switching cell set indicative of switching cells of the switching plane which are used to satisfy the connection demand, wherein satisfying the connection demand includes allocating, by a controller, switching cells of the switching cell set on said one of the multiple parallel instances of the switching plane; and
performing a blocking resolution operation for the connection demand when the first condition fails to hold, the blocking resolution operation including:
identifying a single previously satisfied connection demand which, if removed, would cause the first condition to hold;
de-allocating switching cells used to satisfy said single previously satisfied connection demand on a corresponding one of the multiple parallel instances of the switching plane;
satisfying the connection demand by allocating switching cells of the switching cell set on said corresponding one of the multiple parallel instances of the switching plane; and
marking the single previously satisfied connection demand as being blocked.

2. (canceled)

3. The method of claim 1, further comprising performing the blocking resolution operation for the blocked previously satisfied connection demand.

4. A method for routing received connection demands through a photonic switch having multiple parallel instances of a switching plane, the multiple parallel instances disposed between an input stage and an output stage, the method comprising:
for each connection demand of the received connection demands;
satisfying the connection demand when a first condition holds, the first condition indicative that all switching cells of a determined switching cell set are unallocated for use by previously satisfied connection demands within one of the multiple parallel instances of the switching plane, the switching cell set indicative of switching cells of the switching plane which are used to satisfy the connection demand, wherein satisfying the connection demand includes allocating, by a controller, switching cells of the switching cell set on said one of the multiple parallel instances of the switching plane; and
performing a blocking resolution operation including:
maintaining a list of blocked demands belonging to the received connection demands, the list of blocked demands initially including connection demands for which the first condition initially fails to hold;
while the list of blocked demands includes at least one entry, repeating a blocking resolution operation including:
selecting a blocked demand from the list of blocked demands;
determining a further switching cell set indicative of switching cells of the switching plane which are used to satisfy the blocked demand;
determining whether a second condition holds, the second condition indicative that all switching cells of the further switching cell set are unallocated for use by previously satisfied connection demands within one of the multiple parallel instances of the switching plane;
when the second condition fails to hold, performing a substitution operation including:
identifying a target one of the multiple parallel instances of the switching plane, such that all switching cells of the further switching cell set would be unallocated within the target one of the multiple parallel instances of the switching plane if a single one of the previously satisfied connection demands were removed;
de-allocating switching cells used to satisfy said single one of the previously satisfied connection demands;
adding said single one of the previously satisfied connection demands to the list of blocked demands; and
satisfying the blocked demand by allocating switching cells of the further switching cell set on said target one of the multiple parallel instances of the switching plane.

5. The method of claim 4, further comprising: when the second condition holds, satisfying the blocked demand by allocating switching cells of the switching cell set on said one of the multiple parallel instances of the switching plane.

6. The method of claim 1, wherein:
each instance of the switching plane comprises N inputs, N outputs, and a plurality of switching cells, and is configured controllably route one or more of the N inputs to one or more of the N outputs via operation of said switching cells;
the input stage of the photonic switch comprises N optical inputs operatively coupled to a second plurality of switching cells, the input stage configured to controllably route each of a plurality of the N optical inputs to a corresponding one of the N inputs of a selectable one of the multiple parallel instances of the switching plane; and
the output stage of the photonic switch comprises N optical outputs operatively coupled to a third plurality of switching cells, the output stage configured to controllably feed each of a plurality of the N optical outputs from a corresponding one of the N outputs of a separately selectable one of the multiple parallel instances of the switching plane.

7. A method for routing received connection demands through a photonic switch having multiple parallel instances of a switching plane, the multiple parallel instances disposed between an input stage and an output stage, the method comprising:
for each connection demand of the received connection demands:
satisfying the connection demand when a first condition holds, the first condition indicative that all switching cells of a determined switching cell set are unallocated for use by previously satisfied connection demands within one of the multiple parallel instances of the switching plane, the switching cell set indicative of switching cells of the switching plane which are used to satisfy the connection demand, wherein satisfying the connection demand includes allocating, by a controller, switching cells of the switching cell set on said one of the multiple parallel instances of the switching plane; and
when said connection demands are higher-priority connection demands, routing received lower-priority connection demands through the photonic switch, including:
for each lower-priority connection demand of the received lower-priority connection demands:
when a feasibility condition holds, the feasibility condition indicative that, given configuration of the input stage and the output stage to satisfy the higher-priority connection demands, an optical input and an optical output of the photonic switch, which define the lower-priority connection demand, are both mutable to a common one of the multiple parallel instances of the switching plane; and
when a further first condition holds, satisfying the lower-priority connection demand by allocating switching cells of the switching cell set on said one of the multiple parallel instances of the switching plane, the further first condition indicative that all switching cells of a determined further corresponding switching cell set are unallocated for use by previously satisfied connection demands within one of the multiple parallel instances of the switching plane, the further corresponding switching cell set indicative of switching cells of the switching plane which are used to satisfy the lower-priority connection demand.

8. A method for routing received connection demands through a photonic switch having multiple parallel instances of a switching plane, the multiple parallel instances disposed between an input stage and an output stage, the connection demands including higher priority connection demands and lower priority connection demands, the method comprising:
satisfying the higher priority connection demands; and
for each lower priority connection demand:
when a feasibility condition holds, the feasibility condition indicative that, given configuration of the input stage and the output stage to satisfy the higher priority connection demands, an optical input and an optical output of the photonic switch, which define the higher priority connection demand, are both routable to a common one of the multiple parallel instances of the switching plane; and
when a first condition holds, the first condition indicative that all switching cells of a determined corresponding switching cell set are unallocated for use by previously satisfied connection demands within one of the multiple parallel instances of the switching plane, the corresponding switching cell set indicative of switching cells of the switching plane which are used to satisfy the lower priority connection demand:
satisfying the lower priority connection demand by allocating switching cells of the switching cell set on said one of the multiple parallel instances of the switching plane.

9. The method of claim 8, wherein the first condition is determined to hold when all switching cells of the corresponding switching cell set are unallocated for use by previously satisfied connection demands within a subset of instances of the switching plane, said subset being determined based on said given configuration of the input stage and the output stage to satisfy the higher priority connection demands.

10. An apparatus for operating a photonic switch having multiple parallel instances of a switching plane, the multiple parallel instances disposed between an input stage and an output stage, the apparatus comprising:
a communication interface configured to receive plural connection demands to be accommodated by the photonic switch;
a controller operatively coupled to the communication interface and configured, for each connection demand of the of the received connection demands, to:
satisfy the connection demand when a first condition holds, the first condition indicative that all switching cells of a corresponding switching cell set are unallocated for use by previously satisfied connection demands within one of the multiple parallel instances of the switching plane, the switching cell set indicative of switching cells of the switching plane which are used to satisfy the connection demand, wherein satisfying the connection demand includes allocating switching cells of the switching cell set on said one of the multiple parallel instances of the switching plane; and
determine desired operating states for the allocated switching cells, the desired operating states causing the allocated switching cells to collectively establish a signal path for satisfying the connection demand; and
perform a blocking resolution operation for the connection demand when the first condition fails to hold, the blocking resolution operation including:
identifying a single previously satisfied connection demand which, if removed, would cause the first condition to hold;
de-allocating switching cells used to satisfy said single previously satisfied connection demand on a corresponding one of the multiple parallel instances of the switching plane;
satisfying the connection demand by allocating switching cells of the switching cell set on said corresponding one of the multiple parallel instances of the switching plane; and
marking the single previously satisfied connection demand as being blocked; and
a switch driver operatively coupled to the controller and configured to transmit control signals to switching cells of the photonic switch to cause the switching cells to enter said desired operating states.

11. (canceled)

12. The apparatus of claim 10, wherein the controller is further configured to perform the blocking resolution operation for the blocked previously satisfied connection demand.

13. An apparatus for operating a photonic switch having multiple parallel instances of a switching plane, the multiple parallel instances disposed between an input stage and an output stage, the apparatus comprising:
a communication interface configured to receive plural connection demands to be accommodated by the photonic switch;
a controller operatively coupled to the communication interface and configured, for each connection demand of the of the received connection demands, to:
satisfy the connection demand when a first condition holds, the first condition indicative that all switching cells of a corresponding switching cell set are unallocated for use by previously satisfied connection demands within one of the multiple parallel instances of the switching plane, the switching cell set indicative of switching cells of the switching plane which are used to satisfy the connection demand, wherein satisfying the connection demand includes allocating switching cells of the switching cell set on said one of the multiple parallel instances of the switching plane; and
determine desired operating states for the allocated switching cells, the desired operating states causing the allocated switching cells to collectively establish a signal path for satisfying the connection demand; and
a switch driver operatively coupled to the controller and configured to transmit control signals to switching cells of the photonic switch to cause the switching cells to enter said desired operating states;
wherein the controller is further configured to perform a blocking resolution operation including:
maintaining a list of blocked demands belonging to the received connection demands, the list of blocked demands initially including connection demands for which the first condition initially fails to hold;
while the list of blocked demands includes at least one entry, repeating a blocking resolution operation including:
selecting a blocked demand from the list of blocked demands;
determining a further switching cell set indicative of switching cells of the switching plane which are used to satisfy the blocked demand;
determining whether a second condition holds, the second condition indicative that all switching cells of the further switching cell set are unallocated for use by previously satisfied connection demands within one of the multiple parallel instances of the switching plane;
when the second condition fails to hold, performing a substitution operation including:
identifying a target one of the multiple parallel instances of the switching plane, such that all switching cells of the further switching cell set would be unallocated within the target one of the multiple parallel instances of the switching plane if a single one of the previously satisfied connection demands were removed;
de-allocating switching cells used to satisfy said single one of the previously satisfied connection demands;
adding said single one of the previously satisfied connection demands to the list of blocked demands; and
satisfying the blocked demand by allocating switching cells of the further switching cell set on said target one of the multiple parallel instances of the switching plane.

14. The apparatus of claim 13, further comprising: when the second condition holds, satisfying the blocked demand by allocating switching cells of the switching cell set on said one of the multiple parallel instances of the switching plane.

15. The apparatus of claim 10, wherein:
each instance of the switching plane comprises N inputs, N outputs, and a plurality of switching cells, and is configured controllably route one or more of the N inputs to one or more of the N outputs via operation of said switching cells;
the input stage of the photonic switch comprises N optical inputs operatively coupled to a second plurality of switching cells, the input stage configured to controllably route each of a plurality of the N optical inputs to a corresponding one of the N inputs of a selectable one of the multiple parallel instances of the switching plane; and
the output stage of the photonic switch comprises N optical outputs operatively coupled to a third plurality of switching cells, the output stage configured to controllably feed each of a plurality of the N optical outputs from a corresponding one of the N outputs of a separately selectable one of the multiple parallel instances of the switching plane.

16. An apparatus for operating a photonic switch having multiple parallel instances of a switching plane, the multiple parallel instances disposed between an input stage and an output stage, the apparatus comprising:
a communication interface configured to receive plural connection demands to be accommodated by the photonic switch;
a controller operatively coupled to the communication interface and configured, for each connection demand of the of the received connection demands, to:
satisfy the connection demand when a first condition holds, the first condition indicative that all switching cells of a corresponding switching cell set are unallocated for use by previously satisfied connection demands within one of the multiple parallel instances of the switching plane, the switching cell set indicative of switching cells of the switching plane which are used to satisfy the connection demand, wherein satisfying the connection demand includes allocating switching cells of the switching cell set on said one of the multiple parallel instances of the switching plane; and
determine desired operating states for the allocated switching cells, the desired operating states causing the allocated switching cells to collectively establish a signal path for satisfying the connection demand; and
a switch driver operatively coupled to the controller and configured to transmit control signals to switching cells of the photonic switch to cause the switching cells to enter said desired operating states;
when said connection demands are higher-priority connection demands, the controller further configured to route received lower-priority connection demands through the photonic switch, including:
for each lower-priority connection demand of the received lower-priority connection demands:
when a feasibility condition holds, the feasibility condition indicative that, given configuration of the input stage and the output stage to satisfy the higher-priority connection demands, an optical input and an optical output of the photonic switch, which define the lower-priority connection demand, are both mutable to a common one of the multiple parallel instances of the switching plane; and
when a further first condition holds, satisfying the lower-priority connection demand by allocating switching cells of the switching cell set on said one of the multiple parallel instances of the switching plane, the further first condition indicative that all switching cells of a further corresponding switching cell set are unallocated for use by previously satisfied connection demands within one of the multiple parallel instances of the switching plane, the further corresponding switching cell set indicative of switching cells of the switching plane which are used to satisfy the lower-priority connection demand.

17. An apparatus for routing received connection demands through a photonic switch having multiple parallel instances of a switching plane, the multiple parallel instances disposed between an input stage and an output stage, the apparatus comprising:
a communication interface configured to receive the connection demands, the connection demands including higher priority connection demands and lower priority connection demands;
a controller operatively coupled to the communication interface and configured to:
satisfy the higher priority connection demands; and
for each lower priority connection demand:
when a feasibility condition holds, the feasibility condition indicative that, given configuration of the input stage and the output stage to satisfy the higher priority connection demands, an optical input and an optical output of the photonic switch, which define the higher priority connection demand, are both routable to a common one of the multiple parallel instances of the switching plane; and
when a first condition holds, the first condition indicative that all switching cells of a corresponding switching cell set are unallocated for use by previously satisfied connection demands within one of the multiple parallel instances of the switching plane, the corresponding switching cell set indicative of switching cells of the switching plane which are used to satisfy the lower priority connection demand:
satisfy the lower priority connection demand by allocating switching cells of the switching cell set on said one of the multiple parallel instances of the switching plane; and
determine desired operating states for the allocated switching cells, the desired operating states causing the allocated switching cells to collectively establish a signal path for satisfying the lower priority connection demand; and
a switch driver operatively coupled to the controller and configured to transmit control signals to switching cells of the photonic switch to cause the switching cells to enter said desired operating states.

18. The apparatus of claim 17, wherein the first condition is determined to hold when all switching cells of the corresponding switching cell set are unallocated for use by previously satisfied connection demands within a subset of instances of the switching plane, said subset being determined based on said given configuration of the input stage and the output stage to satisfy the higher priority connection demands.

19. The apparatus of claim 10, further comprising the photonic switch.

20. The apparatus of claim 19, wherein the apparatus is integrated into a switching node.
